(19) United States
(12) Patent Application Publication
(10) Pub. No.: US 2024/0352339 A1
(43) Pub. Date: Oct. 24, 2024

(54) METHODS OF PREPARING CRACKING CATALYSTS FROM CLAY MINERAL COMPOSITIONS AND STEAM ENHANCED CATALYTIC CRACKING OF CRUDE OIL TO PETROCHEMICALS

(71) Applicants: Saudi Arabian Oil Company, Dhahran (SA); King Fahd University of Petroleum and Minerals, Dhahran (SA)

(72) Inventors: Aaron Chi Akah, Dhahran (SA); Musaed Salem Al-Ghrami, Dammam (SA); Rabindran Jermy, Dammam (SA); Abdullah Aitani, Dhahran (SA); Mohammed A.B. Siddiqui, Dhahran (SA)

(73) Assignees: Saudi Arabian Oil Company, Dhahran (SA); King Fahd University of Petroleum and Minerals, Dhahran (SA)

(21) Appl. No.: 18/302,167

(22) Filed: Apr. 18, 2023

(51) Int. Cl. C10G 11/05; B01J 29/04; B01J 29/40; B01J 29/48; B01J 35/00; B01J 35/10; B01J 37/02; B01J 37/08

(52) U.S. Cl. CPC C10G 11/05; B01J 29/045; B01J 29/405; B01J 29/48; B01J 35/394; B01J 35/633; B01J 35/66; B01J 37/0207; B01J 37/0236; B01J 37/08; B01J 2229/18; C10G 2300/1033; C10G 2300/70

(57) ABSTRACT

A method of preparing a cracking catalyst includes converting one or more clay mineral compositions to metakaolin; synthesizing an intermediate ZSM-5 zeolite from the metakaolin, a silica source, and ZSM-5 zeolite seeds; and forming a cracking catalyst comprising a hierarchical mesoporous ZSM-5 zeolite through disintegration and recrystallization of the intermediate ZSM-5 zeolite. A cracking catalyst for steam enhanced catalytic cracking of hydrocarbons includes a hierarchical mesoporous ZSM-5 zeolite impregnated with manganese, zirconium, or manganese and zirconium, where the cracking catalyst has a mesopore volume of at least 0.30 cubic centimeters per gram (cm³/g). A process for upgrading crude oil through steam enhanced catalytic cracking includes contacting the crude oil with steam in the presence of a cracking catalyst, where the cracking catalyst comprises a hierarchical mesoporous ZSM-5 zeolite impregnated with manganese, zirconium, or both manganese and zirconium.

### BACKGROUND

### Field

The present disclosure relates to processes and catalysts for upgrading hydrocarbons to produce greater value petrochemical products and intermediates and, in particular, to processes and cracking catalyst compositions for catalytically cracking crude oil to produce olefins, aromatic compounds, or both.

### Technical Background

The worldwide increasing demand for greater value petrochemical products and chemical intermediates remains a major challenge for many integrated refineries. In particular, the production of some valuable light olefins, such as ethylene and propylene, has attracted increased attention as pure olefin streams are considered the building blocks for polymer synthesis. Additionally, light aromatic compounds, such as benzene, toluene, and mixed xylenes can be useful as fuel blending constituents or can be converted to greater value chemical products and intermediates, which can be used as building blocks in chemical synthesis processes. Petrochemical feeds, such as crude oils, can be converted to petrochemicals, such as fuel blending components and chemical products and intermediates, such as light olefins and light aromatic compounds, which are basic intermediates for a large portion of the petrochemical industry. Crude oil is conventionally processed by distillation followed by various reforming processes, solvent treatments, and hydro-conversion processes to produce a desired slate of fuels, lubricating oil products, chemicals, chemical feedstocks, and the like. Conventional refinery systems generally combine multiple complex refinery units with petrochemical plants to produce greater value petrochemical products and intermediates.

### SUMMARY

Accordingly, there is an ongoing need for cracking catalysts and processes for steam enhanced catalytic cracking of crude oil feeds and other hydrocarbon feeds to produce greater yields of light olefins, light aromatic compounds, or both directly from crude oil with fewer processing steps. The present disclosure is directed to cracking catalysts comprising a hierarchical mesoporous ZSM-5 zeolite made from clay mineral compositions. The present disclosure is also directed to processes for upgrading hydrocarbon feeds, such as but not limited to crude oil, through steam enhanced catalytic cracking using the cracking catalysts. The cracking catalysts of the present disclosure may be capable of producing an increased yield of light olefin products directly from crude oil through steam enhanced catalytic cracking, when compared to conventional cracking catalyst compositions. The processes of the present disclosure may enable the direct conversion of crude oil to light olefins, light aromatic compounds, or both with fewer processing steps and unit operation compared to conventional refinery systems.

According to at least one aspect of the present disclosure, a method of preparing a cracking catalyst may comprise converting one or more clay mineral compositions to metakaolin; synthesizing an intermediate ZSM-5 zeolite from the metakaolin, a silica source, and ZSM-5 zeolite seeds; and forming a cracking catalyst comprising a hierarchical mesoporous ZSM-5 zeolite through disintegration and recrystallization of the intermediate ZSM-5 zeolite.

According to another aspect of the present disclosure, a cracking catalyst for steam enhanced catalytic cracking of hydrocarbons may comprise a hierarchical mesoporous ZSM-5 zeolite impregnated with manganese, zirconium, or manganese and zirconium, where the cracking catalyst has a mesopore volume of at least 0.30 cubic centimeters per gram (cm³/g).

According to another aspect of the present disclosure, a process for upgrading crude oil through steam enhanced catalytic cracking may comprise contacting the crude oil with steam in the presence of a cracking catalyst, where: the cracking catalyst comprises a hierarchical mesoporous ZSM-5 zeolite impregnated with manganese, zirconium, or both manganese and zirconium; the hierarchical mesoporous ZSM-5 zeolite has a mesopore volume of at least 0.30 cubic centimeters per gram (cm³/g); a mass ratio of steam to crude oil is from 0.2 to less than 1; and where the contacting of the crude oil with steam in the presence of the cracking catalyst causes at least a portion of crude oil to undergo cracking reactions to produce a cracked effluent comprising light olefins, light aromatic compounds, or both.

Additional features and advantages of the aspects of the present disclosure will be set forth in the detailed description that follows and, in part, will be readily apparent to a person of ordinary skill in the art from the detailed description or recognized by practicing the aspects of the present disclosure.

### BRIEF DESCRIPTION OF THE DRAWINGS

The following detailed description of the present disclosure may be better understood when read in conjunction with the following drawings in which:

FIG. 1 schematically depicts a generalized flow diagram of a fixed bed reactor system for steam catalytic cracking of hydrocarbons to produce light olefins, light aromatic compounds, or both, according to one or more embodiments shown and described in the present disclosure;

FIG. 2 depicts a flowchart of one embodiment of a method for producing a hierarchical mesoporous ZSM-5 zeolite, according to one or more embodiments shown and described in the present disclosure;

FIG. 3 schematically depicts an upflow fluidized catalytic cracking (FCC) system for upgrading a hydrocarbon feed through steam enhanced fluidized catalytic cracking, according to one or more embodiments shown and described in this disclosure;

FIG. 4 schematically depicts a downflow fluidized catalytic cracking (FCC) system for upgrading a hydrocarbon feed through steam enhanced fluidized catalytic cracking, according to one or more embodiments shown and described in this disclosure;

FIG. 5 graphically depicts X-Ray Diffraction (XRD) spectra for kaolin clay, metakaolin formed from calcining the kaolin clay, and intermediate ZSM-5 zeolites formed from the metakaolin prior to disintegration and recrystallization of the intermediate ZSM-5 zeolite to form the cracking catalyst, according to one or more embodiments shown and described in the present disclosure;

FIG. 6 graphically depicts X-Ray Diffraction (XRD) spectra for the hierarchical mesoporous ZSM-5 zeolite, zeolite beta, and a cracking catalyst that includes the hierarchical mesoporous ZSM-5 zeolite and the zeolite beta, according to one or more embodiments shown and described in the present disclosure;

FIG. 7 graphically depicts X-Ray Diffraction (XRD) spectra for cracking catalysts that include hierarchical mesoporous ZSM-5 zeolites and the zeolite beta, where the hierarchical mesoporous ZSM-5 zeolites have various silica to alumina ratios, according to one or more embodiments shown and described in the present disclosure; and

FIG. 8 schematically depicts a generalized flow diagram of a fixed bed reactor system for evaluating the cracking catalysts, according to one or more embodiments shown and described in the present disclosure.

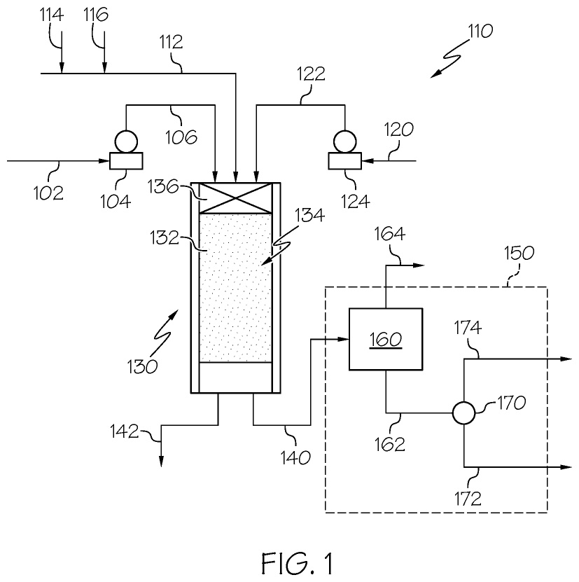

When describing the simplified schematic illustrations of FIGS. 1, 3, 4, and 8, the numerous valves, temperature sensors, electronic controllers, and the like, which may be used and are well known to a person of ordinary skill in the art, may not be depicted. Further, accompanying components that are often included in systems such as those depicted in FIGS. 1, 3, 4, and 8, such as air supplies, heat exchangers, surge tanks, and the like, also may not be depicted. However, a person of ordinary skill in the art understands that these components are within the scope of the present disclosure.

Additionally, the arrows in the simplified schematic illustrations of FIGS. 1, 3, 4, and 8 refer to process streams. However, the arrows may equivalently refer to transfer lines, which may transfer process streams between two or more system components. Arrows that connect to one or more system components signify inlets or outlets in the given system components and arrows that connect to only one system component signify a system outlet stream that exits the depicted system or a system inlet stream that enters the depicted system. The arrow direction generally corresponds with the major direction of movement of the process stream or the process stream contained within the physical transfer line signified by the arrow.

The arrows in the simplified schematic illustrations of FIGS. 1, 3, 4, and 8 may also refer to process steps of transporting a process stream from one system component to another system component. For example, an arrow from a first system component pointing to a second system component may signify “passing” a process stream from the first system component to the second system component, which may comprise the process stream “exiting” or being “removed” from the first system component and “introducing” or “feeding” the process stream to the second system component.

Reference will now be made in greater detail to various aspects, some of which are illustrated in the accompanying drawings.

### DETAILED DESCRIPTION

The present disclosure is directed to cracking catalysts and processes for upgrading hydrocarbon feeds, such as but not limited to crude oil, through steam enhanced catalytic cracking to produce greater yields of petrochemical products or intermediates, such as but not limited to light olefins, light aromatic compounds, or both. In particular, the present disclosure is directed to cracking catalysts that may include a hierarchical mesoporous ZSM-5 zeolite and methods of preparing the cracking catalyst comprising the hierarchical mesoporous ZSM-5 zeolite. The cracking catalyst may be prepared by converting one or more clay mineral compositions to metakaolin, synthesizing an intermediate ZSM-5 zeolite from the metakaolin, a silica source, and ZSM-5 zeolite seeds, and forming a cracking catalyst comprising a hierarchical mesoporous ZSM-5 zeolite through disintegration and recrystallization of the intermediate ZSM-5 zeolite.

A process of the present disclosure for upgrading a hydrocarbon feed through steam enhanced catalytic cracking may include contacting the hydrocarbon feed with steam in the presence of the cracking catalyst at reaction conditions sufficient to cause at least a portion of hydrocarbons in the hydrocarbon feed to undergo one or more cracking reactions to produce a cracking effluent comprising light olefins, light aromatic compounds, or both. The cracking catalyst may comprise the hierarchical mesoporous ZSM-5 zeolite impregnated with manganese, zirconium, or both manganese and zirconium. The process and cracking catalyst may enable the direct conversion of crude oil and other heavy oils to greater value petrochemical products and intermediates, such as but not limited to light olefins, light aromatic compounds, or both, through steam enhanced catalytic cracking. In particular, the cracking catalysts may increase the yield of light olefins and light aromatic compounds from steam enhanced catalytic cracking of crude oil compared to conventional cracking catalysts. The cracking catalysts of the present disclosure may have high hydrothermal stability and longer activity compared to conventional zeolite-based cracking catalysts.

As used in the present disclosure, the term “cracking” refers to a chemical reaction where a molecule having carbon-carbon bonds is broken into more than one molecule by the breaking of one or more of the carbon-carbon bonds or a cyclic molecule having carbon-carbon bonds is converted to a non-cyclic molecule by the breaking or one or more of the carbon-carbon bonds. As used in the present disclosure, the term “catalytic cracking” refers to cracking conducted in the presence of a catalyst.

As used in the present disclosure, the term “catalyst” refers to any substance that increases the rate of a specific chemical reaction, such as but not limited to cracking reactions.

As used in the present disclosure, the term “used catalyst” refers to catalyst that has been contacted with reactants at reaction conditions, but has not been regenerated in a regenerator or through a regeneration process. The “used catalyst” may have coke deposited on the catalyst and may include partially coked catalyst as well as fully coked catalysts. The amount of coke deposited on the “used catalyst” may be greater than the amount of coke remaining on the regenerated catalyst following regeneration. The “used catalyst” may also include catalyst that has a reduced temperature due to contact with the reactants compared to the catalyst prior to contact with the reactants.

As used in the present disclosure, the term “regenerated catalyst” refers to catalyst that has been contacted with reactants at reaction conditions and then regenerated in a regenerator or regenerated through an in-place regeneration process to heat the catalyst to a greater temperature, oxidize and remove at least a portion of the coke or other organic contaminants from the catalyst to restore at least a portion of the catalytic activity of the catalyst, or both. The “regenerated catalyst” may have less coke or organic contaminants, a greater temperature, or both, compared to used catalyst and may have greater catalytic activity compared to used catalyst. The “regenerated catalyst” may have more coke and lesser catalytic activity compared to fresh catalyst that has not been contacted with reactants in a reaction zone and then regenerated.

As used throughout the present disclosure, the term “light olefins” refers to olefinic compounds having less than or equal to 6 carbon atoms.

As used throughout the present disclosure, the term “light aromatic compounds” refers to compounds having an aromatic ring structure and having less than or equal to 10 carbon atoms.

As used throughout the present disclosure, the terms “butenes” or “mixed butenes” are used interchangeably and refer to combinations of one or a plurality of isobutene, 1-butene, trans-2-butene, or cis-2-butene. As used throughout the present disclosure, the term “normal butenes” refers to a combination of one or a plurality of 1-butene, trans-2-butene, or cis-2-butene. As used throughout the present disclosure, the term “2-butenes” refers to trans-2-butene, cis-2-butene, or a combinations of these.

As used in this disclosure, the term “initial boiling point” or “IBP” of a composition refers to the temperature at which the constituents of the composition with the lowest boiling point temperature begin to transition from the liquid phase to the vapor phase. As used in this disclosure, the term “end boiling point” or “EBP” of a composition refers to the temperature at which the greatest boiling temperature constituents of the composition transition from the liquid phase to the vapor phase. A hydrocarbon mixture may be characterized by a distillation profile expressed as boiling point temperatures at which a specific weight percentage of the composition has transitioned from the liquid phase to the vapor phase.

As used in this disclosure, the term “atmospheric boiling point temperature” refers to the boiling point temperature of a compound at atmospheric pressure.

As used in this disclosure, the term “crude oil” or “whole crude oil” is to be understood to mean a mixture of petroleum liquids, gases, or combinations of liquids and gases, including, in some embodiments, impurities such as but not limited to sulfur-containing compounds, nitrogen-containing compounds, and metal compounds, that have not undergone significant separation or reaction processes. Crude oils are distinguished from fractions of crude oil. In certain embodiments, the crude oil feedstock may be a minimally treated light crude oil to provide a crude oil feedstock having total metals (Ni+V) content of less than 5 parts per million by weight (ppmw) and Conradson carbon residue of less than 5 wt. %.

As used in the present disclosure, the term “directly” refers to the passing of materials, such as an effluent, from a first component of a processing system to a second component of the processing system without passing the materials through any intervening components or unit operations operable to change the composition of the materials. Similarly, the term “directly” also refers to the introducing of materials, such as a feed, to a component of the process system without passing the materials through any preliminary components operable to change the composition of the materials. Intervening or preliminary components or systems operable to change the composition of the materials include reactors and separators, but are not generally intended to include heat exchangers, valves, pumps, sensors, or other ancillary components required for operation of a chemical process.

As used in the present disclosure, the terms “downstream” and “upstream” refer to the positioning of components or unit operations of the processing system relative to a direction of flow of materials through the processing system. For example, a second component is considered “downstream” of a first component if materials flowing through the processing system encounter the first component before encountering the second component. Likewise, the first component is considered “upstream” of the second component if the materials flowing through the processing system encounter the first component before encountering the second component.

As used in the present disclosure, the term “effluent” refers to a stream that is passed out of a reactor, a reaction zone, or a separator following a particular reaction or separation. Generally, an effluent has a different composition than the stream that entered the reactor, reaction zone, or separator. It should be understood that when an effluent is passed to another component or system, only a portion of that effluent may be passed. For example, a slipstream may carry some of the effluent away, meaning that only a portion of the effluent may enter the downstream component or system. The terms “reaction effluent” and “reactor effluent” particularly refer to a stream that is passed out of a reactor or reaction zone.

The term “residence time” refers to the amount of time that reactants are in contact with a catalyst, at reaction conditions, such as at the reaction temperature.

As used in the present disclosure, the term “reactor” refers to any vessel, container, conduit, or the like, in which one or more chemical reactions, such as but not limited catalytic cracking reactions, may occur between one or more reactants optionally in the presence of one or more catalysts. One or more “reaction zones” may be disposed within a reactor. The term “reaction zone” refers to a volume where a particular chemical reaction takes place in a reactor.

As used in the present disclosure, the terms “separation unit” and “separator” refer to any separation device(s) that at least partially separates one or more chemical constituents in a mixture from one another. For example, a separation system selectively separates different chemical constituents from one another, forming one or more chemical fractions. Examples of separation systems include, without limitation, distillation columns, fractionators, flash drums, flash columns, knock-out drums, knock-out pots, centrifuges, decanters, filtration devices, traps, scrubbers, expansion devices, membranes, solvent extraction devices, adsorption devices, chemical separators, crystallizers, chromatographs, precipitators, evaporators, driers, high-pressure separators, low-pressure separators, or combinations or these. The separation processes described in the present disclosure may not completely separate all of one chemical constituent from all of another chemical constituent. Instead, the separation processes described in the present disclosure “at least partially” separate different chemical constituents from one another and, even if not explicitly stated, separation can include only partial separation.

It should further be understood that streams may be named for the components of the stream, and the component for which the stream is named may be the major component of the stream (such as the component comprising the greatest fraction of the stream, excluding diluent gases, such as nitrogen, noble gases, and the like, unless otherwise stated). It should also be understood that components of a stream are disclosed as passing from one system component to another when a stream comprising that component is disclosed as passing from that system component to another. For example, a disclosed “nitrogen stream” passing to a first system component or from a first system component to a second system component should be understood to equivalently disclose “nitrogen” passing to the first system component or passing from a first system component to a second system component.

Conventional refinery systems include multiple unit operations. Steam enhanced catalytic cracking of crude oil directly can reduce the complexity of the refining process, such as by reducing the number of unit operations needed to process the crude oil to produce greater value petrochemical products and intermediates, such as but not limited to light olefins and light aromatic compounds. Steam enhanced catalytic cracking processes can utilize zeolites, such as ZSM-5 zeolites, which typically have a microporous pore structure having average pore size of less than 2 nanometers (nm). However, when cracking crude oil directly, crude oil can include a substantial amount of large molecules, such as up to 30 wt. % hydrocarbons having boiling point temperatures greater than or equal to 500° C. These large hydrocarbon molecules are not generally accessible to reactive sites in a conventional microporous ZSM-5 zeolite. Large molecules in crude oil can also plug the pores in the conventional ZSM-5 zeolite, which can reduce the effectiveness of the conventional ZSM-5 zeolites for steam enhanced catalytic cracking of crude oil and other hydrocarbon feeds.

The present disclosure is directed to steam catalytic cracking of crude oil using a cracking catalyst to convert the crude oil to greater value hydrocarbon products, such as but not limited to light olefins, aromatic compounds, or combinations of these. The cracking catalyst can comprise a hierarchical mesoporous ZSM-5 zeolite. The hierarchical mesoporous ZSM-5 zeolite in the cracking catalyst of the present disclosure may have a microporous structure characteristic of ZSM-5 zeolites and also can have mesopores large enough to increase access to reactive sites and to reduce blockage of the reaction sites by large molecules from the crude oil. The present disclosure is also directed to the cracking catalyst and methods of preparing the cracking catalyst comprising the hierarchical mesoporous ZSM-5 zeolite.

Referring now to FIG. 1, a process 100 of the present disclosure for converting a hydrocarbon feed 102 to light olefins, light aromatic compounds, or both, includes contacting the hydrocarbon feed 102 with steam in the presence of a cracking catalyst 132 at reaction conditions sufficient to cause at least a portion of hydrocarbons in the hydrocarbon feed 102 to undergo one or more cracking reactions to produce a steam catalytic cracking effluent 140 comprising light olefins, light aromatic compounds, or both, where the cracking catalyst 132 comprises a hierarchical mesoporous ZSM-5 zeolite.

The hydrocarbon feed 102 may include one or more heavy oils, such as but not limited to crude oil, bitumen, oil sand, shale oil, coal liquids, vacuum residue, tar sands, other heavy oil streams, or combinations of these. It should be understood that, as used in this disclosure, a “heavy oil” refers to a raw hydrocarbon, such as whole crude oil, which has not been previously processed through distillation, or may refer to a hydrocarbon oil, which has undergone some degree of processing, such as but not limited to desalting, prior to being introduced to the process 100 as the hydrocarbon feed 102. The hydrocarbon feed 12 may have a density of greater than or equal to 0.80 grams per milliliter. The hydrocarbon feed 12 may have an end boiling point (EBP) of greater than 565° C. The hydrocarbon feed 12 may have a concentration of nitrogen of less than or equal to 3000 parts per million by weight (ppmw).

In embodiments, the hydrocarbon feed 102 may be a crude oil, such as whole crude oil, a synthetic crude oil, or a mixture of both. The crude oil may have an American Petroleum Institute (API) gravity of from 22 degrees to 50 degrees, such as from 22 degrees to 40 degrees, from 25 degrees to 50 degrees, or from 25 degrees to 40 degrees. For example, the hydrocarbon feed 102 may include an extra light crude oil, a light crude oil, a heavy crude oil, or combinations of these. In embodiments, the hydrocarbon feed 102 can be a light crude oil, such as but not limited to an Arab light export (AL) crude oil. Example properties for an exemplary grade of AL crude oil are provided in Table 1.

TABLE 1
Example of AL Export Feedstock

| Analysis | Units | Value | Test Method |
|---|---|---|---|
| American Petroleum | degree | 33.13 | ASTM D287 |
| Institute (API) gravity | | | |
| Density | grams per milliliter | 0.8595 | ASTM D287 |
| | (g/mL) | | |
| Carbon Content | weight percent (wt. %) | 85.29 | ASTM D5291 |
| Hydrogen Content | wt. % | 12.68 | ASTM D5292 |
| Sulfur Content | wt. % | 1.94 | ASTM D5453 |
| Nitrogen Content | parts per million by | 849 | ASTM D4629 |
| | weight (ppmw) | | |
| Asphaltenes | wt. % | 1.2 | ASTM D6560 |
| Micro Carbon Residue | wt. % | 3.4 | ASTM D4530 |
| (MCR) | | | |
| Vanadium (V) Content | ppmw | 15 | IP 501 |
| Nickel (Ni) Content | ppmw | 12 | IP 501 |
| Arsenic (As) Content | ppmw | 0.04 | IP 501 |

Boiling Point Distribution

| | | | |
|---|---|---|---|
| Initial Boiling Point | Degrees Celsius (° C.) | 33 | ASTM D7169 |
| (IBP) | | | |
| 5% Boiling Point (BP) | ° C. | 92 | ASTM D7169 |
| 10% BP | ° C. | 133 | ASTM D7169 |
| 20% BP | ° C. | 192 | ASTM D7169 |
| 30% BP | ° C. | 251 | ASTM D7169 |
| 40% BP | ° C. | 310 | ASTM D7169 |
| 50% BP | ° C. | 369 | ASTM D7169 |
| 60% BP | ° C. | 432 | ASTM D7169 |
| 70% BP | ° C. | 503 | ASTM D7169 |
| 80% BP | ° C. | 592 | ASTM D7169 |
| 90% BP | ° C. | >720 | ASTM D7169 |
| 95% BP | ° C. | >720 | ASTM D7169 |
| End Boiling Point (EBP) | ° C. | >720 | ASTM D7169 |
| BP range C5-180° C. | wt. % | 18.0 | ASTM D7169 |
| BP range 180° C.-350° C. | wt. % | 28.8 | ASTM D7169 |
| BP range 350° C.-540° C. | wt. % | 27.4 | ASTM D7169 |
| BP range >540° C. | wt. % | 25.8 | ASTM D7169 |

Weight percentages in Table 1 are based on the total weight of the crude oil.

In embodiments, the hydrocarbon feed 102 may be an Arab Extra Light (AXL) crude oil. An example boiling point distribution for an exemplary grade of an AXL crude oil is provided in Table 2.

TABLE 2

| Property | Units | Value | Test Method |
|---|---|---|---|
| 0.1% Boiling Point (BP) | ° C. | 21 | ASTM D7169 |
| 5% BP | ° C. | 65 | ASTM D7169 |
| 10% BP | ° C. | 96 | ASTM D7169 |
| 15% BP | ° C. | 117 | ASTM D7169 |
| 20% BP | ° C. | 141 | ASTM D7169 |
| 25% BP | ° C. | 159 | ASTM D7169 |
| 30% BP | ° C. | 175 | ASTM D7169 |
| 35% BP | ° C. | 196 | ASTM D7169 |
| 40% BP | ° C. | 216 | ASTM D7169 |
| 45% BP | ° C. | 239 | ASTM D7169 |
| 50% BP | ° C. | 263 | ASTM D7169 |
| 55% BP | ° C. | 285 | ASTM D7169 |
| 60% BP | ° C. | 308 | ASTM D7169 |
| 65% BP | ° C. | 331 | ASTM D7169 |
| 70% BP | ° C. | 357 | ASTM D7169 |
| 75% BP | ° C. | 384 | ASTM D7169 |
| 80% BP | ° C. | 415 | ASTM D7169 |
| 85% BP | ° C. | 447 | ASTM D7169 |
| 90% BP | ° C. | 486 | ASTM D7169 |
| 95% BP | ° C. | 537 | ASTM D7169 |
| End Boiling Point (EBP) | ° C. | 618 | ASTM D7169 |

When the hydrocarbon feed 102 comprises a crude oil, the crude oil may be a whole crude or may be a crude oil that has undergone at some processing, such as desalting, solids separation, scrubbing, or other preliminary processing that does not involve separation of the crude oil into different boiling range fraction. For example, the hydrocarbon feed 102 may be a de-salted crude oil that has been subjected to a de-salting process. In embodiments, the hydrocarbon feed 102 may include a crude oil that has not undergone pretreatment, separation (such as distillation), or other operation or process that changes the hydrocarbon composition of the crude oil prior to introducing the crude oil to the system 100.

In embodiments, the hydrocarbon feed 102 can be a crude oil having a boiling point profile as described by the 5 wt. % boiling temperature, the 25 wt. % boiling temperature, the 50 wt. % boiling temperature, the 75 wt. % boiling temperature, and the 95 wt. % boiling temperature. These respective boiling temperatures correspond to the temperatures at which a given weight percentage of the hydrocarbon feed stream boils (transitions from liquid phase to vapor phase). In embodiments, the crude oil may have one or more of a 5 wt. % boiling temperature of less than or equal to 150° C.; a 25 wt. % boiling temperature of less than or equal to 225° C. or less than or equal to 200° C.; a 50 wt. % boiling temperature of less than or equal to 500° C., less than or equal 450° C., or less than or equal to 400° C.; a 75 wt. % boiling temperature of less than 600° C., less than or equal to 550° C.; a 95 wt. % boiling temperature of greater than or equal to 550° C. or greater than or equal to 600° C.; or combinations of these. In embodiments, the crude oil may have one or more of a 5 wt. % boiling temperature of from 0° C. to 100° C.; a 25 wt. % boiling temperature of from 150° C. to 250° C., a 50 wt. % boiling temperature of from 250° C. to 400° C., a 75 wt. % boiling temperature of from 350° C. to 600° C. and an end boiling point temperature of from 500° C. to 1000° C., such as from 500° C. to 800° C.

Referring again to FIG. 1, one embodiment of a steam catalytic cracking system 110 for steam catalytic cracking a hydrocarbon feed 102 is schematically depicted. The steam catalytic cracking system 110 may include at least one steam catalytic cracking reactor 130. The steam catalytic cracking reactor 130 may include one or more fixed bed reactors, fluid bed reactors, batch reactors, fluid catalytic cracking (FCC) reactors, moving bed catalytic cracking reactors, or combinations of these. In embodiments, the steam catalytic cracking reactor 130 may be a fixed bed reactor. In embodiments, the steam catalytic cracking reactor 130 may include a plurality of fixed bed reactors operated in a swing mode. Operation of the steam catalytic cracking reactor 130 will be described herein in the context of a fixed bed reactor. However, it is understood that other types of reactors, such as a fluid bed reactors, batch reactors, FCC reactors, or moving bed reactors, may also be used to contact the hydrocarbon feed 102 with the cracking catalyst to conduct the steam enhanced catalytic cracking of the process disclosed herein.

The steam catalytic cracking reactor 130 may operate to contact the hydrocarbon feed 102 with steam in the presence of the cracking catalyst of the present disclosure to produce a steam cracking effluent comprising light olefins, aromatic compounds, or combinations of these. As previously discussed, the steam catalytic cracking reactor 130 may be a fixed bed catalytic cracking reactor that may include the cracking catalyst 132 disposed within a steam catalytic cracking zone 134. The steam catalytic cracking reactor 130 may include a porous packing material 136, such as silica carbide packing, upstream of the steam catalytic cracking zone 134. The porous packing material 136 may ensure sufficient heat transfer to the hydrocarbon feed 102 and steam prior to conducting the steam catalytic cracking reaction in the steam catalytic cracking zone 134.

Referring again to FIG. 1, the hydrocarbon feed 102 may be introduced to the steam catalytic cracking reactor 130. In embodiments, the hydrocarbon feed 102 may be introduced directly to the steam catalytic cracking system 110, such as by passing the crude oil of the hydrocarbon feed 102 to the steam catalytic cracking reactor 130 without passing the hydrocarbon feed 102 to any separation system or unit operation that changes the hydrocarbon composition of the hydrocarbon feed 102. In embodiments, the hydrocarbon feed 102 may be processed upstream of the steam catalytic cracking system 110 to remove contaminants, such as but not limited to nitrogen compounds, sulfur-containing compounds, heavy metals, or other contaminants that may reduce the effectiveness of the cracking catalyst 132.

Introducing the hydrocarbon feed 102 to the steam catalytic cracking reactor 130 may include heating the hydrocarbon feed 102 to a temperature of from 35° C. to 150° C. and then passing the hydrocarbon feed 102 to the steam catalytic cracking reactor 130. In embodiments, the hydrocarbon feed 102 may be pre-heated to a temperature of from 40° C. to 150° C., from 45° C. to 150° C., from 50° C. to 150° C., from 35° C. to 145° C., from 40° C. to 145° C., from 45° C. to 145° C., from 35° C. to 140° C., from 40° C. to 140° C., or from 45° C. to 140° C.

In embodiments, passing the hydrocarbon feed 102 to the steam catalytic cracking reactor 130 may include passing the hydrocarbon feed 102 to a feed pump 104, where the feed pump 104 may increase the pressure of the hydrocarbon feed 102 and convey the hydrocarbon feed 102 to the steam catalytic cracking reactor 130. The flowrate of the feed pump 104 may be adjusted so that the hydrocarbon feed 102 is injected into the steam catalytic cracking reactor 130 at a gas hourly space velocity of greater than or equal to 0.1 per hour (h⁻¹) or greater than or equal to 0.25 h⁻¹. The hydrocarbon feed 102 may be injected into the steam catalytic cracking reactor 130 at a gas hourly space velocity of less than or equal to 50 h⁻¹, less than or equal to 25 h⁻¹, less than or equal to 20 h⁻¹, less than or equal to 14 h⁻¹, less than or equal to 9 h⁻¹, or less than or equal to 5 h⁻¹. The hydrocarbon feed 102 may be injected into the steam catalytic cracking reactor 130 at a gas hourly space velocity of from 0.1 h⁻¹ to 50 h⁻¹, from 0.1 h⁻¹ to 25 h⁻¹, from 0.1 h⁻¹ to 20 h⁻¹, from 0.1 h⁻¹ to 14 h⁻¹, from 0.1 h⁻¹ to 9 h⁻¹, from 0.1 h⁻¹ to 5 h⁻¹, from 0.1 h⁻¹ to 4 h⁻¹, from 0.25 h⁻¹ to 50 h⁻¹, from 0.25 h⁻¹ to 25 h⁻¹, from 0.25 h⁻¹ to 20 h⁻¹, from 0.25 h⁻¹ to 14 h⁻¹, from 0.25 h⁻¹ to 9 h⁻¹, from 0.25 h⁻¹ to 5 h⁻¹, from 0.25 h⁻¹ to 4 h⁻¹, from 1 h⁻¹ to 50 h⁻¹, from 1 h⁻¹ to 25 h⁻¹, from 1 h⁻¹ to 20 h⁻¹, from 1 h⁻¹ to 14 h⁻¹, from 1 h⁻¹ to 9 h⁻¹, or from 1 h⁻¹ to 5 h⁻¹ via feed inlet line 106. The hydrocarbon feed 102 may be further pre-heated in the feed inlet line 106 to a temperature of from 100° C. to 250° C. before injecting the hydrocarbon feed 102 into the steam catalytic cracking reactor 130.

Water 120 may be injected into the steam catalytic cracking reactor 130 through water feed line 122 via the water feed pump 124. The water feed line 122 may be pre-heated to heat the water 120 to a temperature of from 50° C. to 175° C., from 50° C. to 150° C., from 60° C. to 175° C., or from 60° C. to 170° C. The water 120 may be converted to steam in water feed line 122 or upon contact with the hydrocarbon feed 102 in the steam catalytic cracking reactor 130. The flowrate of the water feed pump 124 may be adjusted to deliver the water 120 (liquid, steam, or both) to the steam catalytic cracking reactor 130 at a gas hourly space velocity of greater than or equal to 0.1 per hour (h⁻¹), greater than or equal to 0.5 h⁻¹, greater than or equal to 1 h⁻¹, greater than or equal to 5 h⁻¹, greater than or equal to 6 h⁻¹, greater than or equal to 10 h⁻¹, or even greater than or equal to 15 h⁻¹. The water 120 may be introduced to the steam catalytic cracking reactor 130 at a gas hourly space velocity of less than or equal to 100 h⁻¹, less than or equal to 75 h⁻¹, less than or equal to 50 h⁻¹, less than or equal to 30 h⁻¹, or less than or equal to 20 h⁻¹. The water 120 may be introduced to the steam catalytic cracking reactor 130 at a gas hourly space velocity of from 0.1 h⁻¹ to 100 h⁻¹, from 0.1 h⁻¹ to 75 h⁻¹, from 0.1 h⁻¹ to 50 h⁻¹, from 0.1 h⁻¹ to 30 h⁻¹, from 0.1 h⁻¹ to 20 h⁻¹, from 1 h⁻¹ to 100 h⁻¹, from 1 h⁻¹ to 75 h⁻¹, from 1 h⁻¹ to 50 h⁻¹, from 1 h⁻¹ to 30 h⁻¹, or from 1 h⁻¹ to 20 h⁻¹.

The steam produced from injection of the water 120 into the steam catalytic cracking reactor 130 may reduce the hydrocarbon partial pressure, which may have the dual effects of increasing yields of light olefins (e.g., ethylene, propylene and butylene) as well as reducing coke formation on the cracking catalyst. Not intending to be limited by any particular theory, it is believed that light olefins like propylene and mixed butenes are mainly generated from catalytic cracking reactions following the carbonium ion mechanism, and as these are intermediate products, they can undergo secondary reactions such as hydrogen transfer and aromatization (leading to coke formation). The steam may increase the yield of light olefins by suppressing these secondary bi-molecular reactions, and may reduce the concentration of reactants and products, which favor selectivity towards light olefins. The steam may also suppress secondary reactions that are responsible for coke formation on the catalyst surface, which is good for catalysts to maintain high average activation. These factors may show that a large steam-to-oil weight ratio may be beneficial to the production of light olefins.

The mass flow rate of the water 120 to the steam catalytic cracking reactor 130 may be less than the mass flow rate of the hydrocarbon feed 102 to the steam catalytic cracking reactor 130. In embodiments, a mass flow ratio of the water 120 (steam) to the hydrocarbon feed 102 introduced to the steam catalytic cracking reactor 130 can be less than 1, such as less than or equal to 0.9, less than or equal to 0.8, less than or equal to 0.7, or less than or equal to 0.6. In embodiments, the mass flow ratio of the water 120 to the hydrocarbon feed 102 introduced to the steam catalytic cracking reactor 130 can be from 0.2 to less than 1, from 0.2 to 0.9, from 0.2 to 0.8, from 0.2 to 0.7, from 0.2 to 0.6, from 0.3 to less than 1, from 0.3 to 0.9, from 0.3 to 0.8, from 0.3 to 0.7, from 0.3 to 0.6, from 0.4 to less than 1, from 0.4 to 0.9, from 0.4 to 0.8, from 0.4 to 0.7, from 0.4 to 0.6, from 0.5 to less than 1, from 0.5 to 0.9, from 0.5 to 0.8, from 0.5 to 0.7, from 0.5 to 0.6. In embodiments, the mass flow ratio of the water 120 to the hydrocarbon feed 102 introduced to the steam catalytic cracking reactor 130 can be about 0.5. The water may be present as steam in the steam catalytic cracking reactor 130.

Referring again to FIG. 1, the steam catalytic cracking system 110 may be operable to contact the hydrocarbon feed 102 with steam (from water 120) in the presence of the cracking catalyst 132 in the steam catalytic cracking reactor 130 under reaction conditions sufficient to cause at least a portion of the hydrocarbons from the hydrocarbon feed 102 to undergo one or more cracking reactions to produce a steam catalytic cracking effluent 140 comprising light olefins, light aromatic compounds, or both. In embodiments, the steam catalytic cracking effluent 140 may comprise light olefins, which may include but are not limited to ethylene, propylene, mixed butenes, or combinations of these. In embodiments, the steam catalytic cracking effluent 140 may comprise light aromatic compounds, which refers to compounds containing an aromatic ring structure and having less than or equal to 10 carbon atoms. The light aromatic compounds in the steam catalytic cracking effluent 140 may include but are not limited to benzene, toluene, ethylbenzene, mixed xylenes, or other light aromatic compounds.

The steam catalytic cracking reactor 130 may be operated at a temperature of greater than or equal to 525° C., greater than or equal to 550° C., greater than or equal to 575° C., or even greater than or equal to 600° C. The steam catalytic cracking reactor 130 may be operated at a temperature of less than or equal to 800° C., less than or equal to 750° C., less than or equal to 700° C., or even less than or equal to 675° C. The steam catalytic cracking reactor 130 may be operated at a temperature of from 525° C. to 800° C., from 525° C. to 750° C., from 525° C. to 700° C., from 525° C. to 675° C., from 550° C. to 750° C., from 550° C. to 700° C., from 550° C. to 675° C., from 575° C. to 750° C., from 575° C. to 700° C., from 575° C. to 675° C., from 600° C. to 750° C., from 600° C. to 700° C., or from 600° C. to 675° C. In embodiments, the steam catalytic cracking reactor 130 may be operated at a temperature of about 675° C. The process may operate at atmospheric pressure (approximately from 1 to 2 bar (100 kPa to 200 kPa)).

The methods of the present disclosure may include contacting the hydrocarbon feed 102 with the steam (water 120) in the presence of the cracking catalyst 132 in the steam catalytic cracking reactor 130 for a residence time sufficient to convert at least a portion of the hydrocarbon compounds in the hydrocarbon feed 102 to light olefins, light aromatic compounds, or both. In embodiments, the methods may include contacting the hydrocarbon feed 102 with the steam (water 120) in the presence of the cracking catalyst 132 in the steam catalytic cracking reactor 130 for a residence time of from 1 second to 60 seconds, such as from 5 seconds to 30 seconds, or about 10 seconds.

When the steam catalytic cracking reactor 130 is a fixed bed reactor, the steam catalytic cracking reactor 130 may be operated in a semi-continuous manner. For example, during a conversion cycle, the steam catalytic cracking reactor 130 may be operated with the hydrocarbon feed 102 and water 120 flowing to the steam catalytic cracking reactor 130 for a period of time. After the period of the time, the cracking catalyst 132 may be regenerated. Each conversion cycle of the steam catalytic cracking reactor 130 may be from 2 to 24 hours, from 2 to 20 hours, from 2 to 16 hours, from 2 to 12 hours, from 2 to 10 hours, from 2 to 8 hours, from 4 to 24 hours, from 4 to 20 hours, from 4 to 16 hours, from 4 to 12 hours, from 4 to 10 hours, from or 4 to 8 hours before switching off the feed pump 104 and the water feed pump 124 to cease the flow of hydrocarbon and steam to the steam catalytic cracking reactor 130.

At the end of the conversion cycle, the flow of hydrocarbon feed 102 and water 120 may be stopped and the cracking catalyst 132 may be regenerated during a regeneration cycle. In embodiments, the steam catalytic cracking system 110 may include a plurality of fixed bed steam catalytic cracking reactors 130, which may be operated in parallel or in series. In embodiments, the steam catalytic cracking system 110 may include 2, 3, 4, 5, 6, or more than 6 steam catalytic cracking reactors 130, which may be operated in series or in parallel. With a plurality of steam catalytic cracking reactors 130 operating in parallel, one or more of the steam catalytic cracking reactors 130 can continue in a conversion cycle while one or more of the other steam catalytic cracking reactors 130 are taken off-line for regeneration of the cracking catalyst 132, thus maintaining continuous operation of the steam catalytic cracking system 110.

Referring again to FIG. 1, during a regeneration cycle, the steam catalytic cracking reactor 130 may be operated to regenerate the cracking catalyst 132. The cracking catalyst 132 may be regenerated to remove coke deposits accumulated during the conversion cycle. To regenerate the cracking catalyst 132, hydrocarbon gas and liquid products produced by the steam catalytic cracking process may be evacuated from the steam catalytic cracking reactor 130. Nitrogen gas 114 may be introduced to the steam catalytic cracking reactor 130 through gas inlet line 112 to evacuate the hydrocarbon gas and liquid products from the fixed bed steam catalytic cracking reactor 130. The nitrogen gas 114 may be introduced to the steam catalytic cracking reactor 130 at gas hourly space velocity of from 10 per hour (h⁻¹) to 100 h⁻¹.

Following evacuation of the hydrocarbon gases and liquids, air 116 may be introduced to the steam catalytic cracking reactor 130 through the gas inlet line 112 at a gas hourly space velocity of from 10 h⁻¹ to 100 h⁻¹. The air may be passed out of the steam catalytic cracking reactor 130 through air outlet line 142. While passing air 116 through the cracking catalyst 132 in the steam catalytic cracking reactor 130, the temperature of the steam catalytic cracking reactor 130 may be adjusted from the reaction temperature to a regeneration temperature of from 650° C. to 750° C. for a period of from 3 hours to 5 hours. The gas produced by air regeneration of the cracking catalyst 132 may be passed out of the steam catalytic cracking reactor 130 and may be analyzed by an in-line gas analyzer to detect the presence or concentration of carbon dioxide produced through de-coking of the cracking catalyst 132. Once the carbon dioxide concentration in the gases passing out of the steam catalytic cracking reactor 130 are reduced to less than 0.05% to 0.1% by weight, as determined by the in-line gas analyzer, the temperature of the steam catalytic cracking reactor 130 may be decreased from the regeneration temperature back to the reaction temperature. The air flow through gas inlet line 112 may be stopped. Nitrogen gas may be passed through the cracking catalyst 132 for 15 to 30 minutes to remove air from the steam catalytic cracking reactor 130. Following treatment with nitrogen, the flows of the hydrocarbon feed 102 and water 120 may be resumed to begin another conversion cycle of steam catalytic cracking reactor 130. Although described herein in the context of a fixed bed reactor system, it is understood that the steam catalytic cracking reactor 130 can be a different type of reactor, such as a fluidized bed reactor, a moving bed reactor, a batch reactor, an FCC reactor, or combinations of these.

Referring again to FIG. 1, the steam catalytic cracking effluent 140 may pass out of the steam catalytic cracking reactor 130. The steam catalytic cracking effluent 140 may include one or more products and intermediates, such as but not limited to light hydrocarbon gases, light olefins, aromatic compounds, pyrolysis oil, or combinations of these. The light olefins in the steam catalytic cracking effluent 140 may include ethylene, propylene, butenes, or combinations of these.

As previously discussed, the cracking catalyst can comprise a hierarchical mesoporous ZSM-5 zeolite. The cracking catalyst may be prepared by a method that includes producing the hierarchical mesoporous ZSM-5 zeolite from one or more clay mineral compositions.

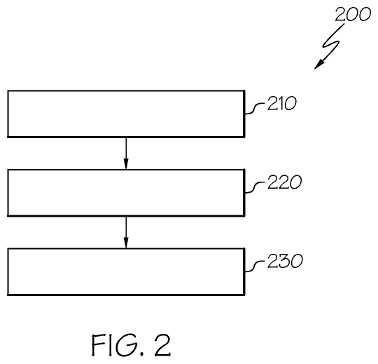

Referring now to FIG. 2, a method 200 of preparing the cracking catalyst is depicted. The method 200 may include converting one or more clay mineral compositions to metakaolin, in step 210; synthesizing an intermediate ZSM-5 zeolite from the metakaolin, a silica source, and ZSM-5 zeolite seeds, in step 220; and forming a cracking catalyst comprising a hierarchical mesoporous ZSM-5 zeolite through disintegration and recrystallization of the intermediate ZSM-5 zeolite, in step 230. A hierarchical pore structure of the hierarchical mesoporous ZSM-5 zeolite may include micropores and mesopores.

As described herein, at step 210, the method may include converting one or more clay mineral compositions to metakaolin. The clay mineral compositions may comprise one or more clay minerals, such as kaolinite and halloysite. In embodiments, two or more clay mineral compositions may be used. That is, in embodiments, at least two separate clay mineral compositions comprising a different weight percentage of clay minerals may be used as described herein. The converting may include calcining the one or more clay mineral compositions to form the metakaolin. The calcining may comprise heating the one or more clay mineral compositions to an elevated temperature, and holding the temperature of the clay mineral compositions at an elevated temperature for a duration of time in an environment comprising oxygen. A clay mineral composition may comprise one or more clay minerals, such as kaolinite and halloysite. In embodiments, two or more clay mineral compositions may be used. That is, in embodiments, at least two separate clay mineral compositions comprising a different weight percentage of clay minerals may be used as described herein.

In embodiments, the one or more clay mineral compositions may comprise, consist essentially of, or consist of kaolin. As used herein, “kaolin” or “kaolin clay” refers to a class of clay minerals comprising the chemical formula Al₂Si₂O₅(OH)₄, which may include the clay minerals kaolinite, halloysite, dickite, and nacrite. In embodiments, the one or more clay mineral compositions may comprise halloysite, kaolinite, dickite, nacrite or combinations thereof. Kaolinite has the chemical formula Al₂Si₂O₅(OH)₄, and may occur in platy forms. Halloysite has a similar composition to kaolinite except that halloysite may naturally occur as small cylinders and may have additional water molecules. In its fully hydrated form, halloysite has additional water molecules between layers of the crystal structure and has a chemical formula of Al₂Si₂O₅(OH)₄·2H₂O. Halloysite may also be partially dehydrated, meaning that at least a portion of the water molecules have been removed from the halloysite structure. As used herein, the term “halloysite” is used to refer to both the fully hydrated and partially hydrated forms of halloysite, unless specified otherwise. Without intending to be bound by any particular theory, it is believed that ZSM-5 zeolites synthesized from clay mineral compositions may have a reduced acid strength compared to ZSM-5 zeolites synthesized by conventional methods. The reduced acid strength of the ZSM-5 zeolites as described herein, may reduce the occurrence of secondary reactions that lead to coke formation or hydrogenation of light olefins during the upgrading processes described herein, which may increase selectivity of light olefins.

In embodiments, the one or more clay minerals may be naturally occurring. As used herein, “naturally occurring” refers to clay minerals that are not artificially synthesized by man-made processes. In embodiments, the naturally occurring clay minerals may be processed. For instance, the clay minerals may be processed to remove impurities. Without intending to be bound by any particular theory, it is believed that the use of clay minerals that are naturally occurring may improve the environmental footprint of the methods disclosed in the present disclosure compared to using clay minerals that are artificially synthesized. Further, it is believed that the use of clay mineral that are naturally occurring may reduce the operational cost for producing zeolites disclosed in the present disclosure.

In embodiments, calcining the clay minerals may comprise heating the clay minerals at a temperature of greater than or equal to 550° C., such as greater than or equal to 600° C., or greater than or equal to 650° C. In embodiments, calcining the one or more clay minerals may comprise heating the one or more clay minerals at a temperature of from 550° C. to 900° C., such as from 550° C. to 800° C., from 550° C. to 750° C., from 600° C. to 900° C., from 600° C. to 800° C., from 600° C. to 750° C., from 650° C. to 900° C., from 650° C. to 800° C., or from 650° C. to 750° C. In embodiments, calcining the one or more clay minerals may comprise heating the one or more clay minerals for a duration of greater than or equal to 10 minutes (min), such as greater than or equal to 30 min, greater than or equal to 60 min, or greater than or equal to 90 min. In embodiments, calcining the one or more clay minerals may comprise heating the one or more clay minerals for a duration of from 10 min to 2 days.

In embodiments, at least a portion of the clay mineral compositions may be converted to metakaolin, such as through calcining. As used herein, “metakaolin” refers to a compound comprising chemical formula Al₂Si₂O₇. Metakaolin may be formed by heating kaolin, such as one or more clay mineral compositions to an elevated temperature for a duration of time.

Surface area, pore volume, average pore size, and pore size distribution may be measured by nitrogen (N₂) adsorption isotherms performed at 77 Kelvin (K) (such as with a Micrometrics ASAP 2020 system). As would be understood by those skilled in the art, Brunauer, Emmett, and Teller (BET) analysis methods may be utilized to calculate the surface area from the N₂ adsorption isotherms, and the Barrett, Joyner and Halenda (BJH) calculation method may be used to determine pore volume and pore size distribution from the N₂ adsorption isotherms.

In embodiments, the metakaolin converted from the clay mineral compositions may have a surface area of greater than or equal to 30 m²/g, such as greater than or equal to 35 m²/g, greater than or equal to 40 m²/g, greater than or equal to 45 m²/g, greater than or equal to 50 m²/g, greater than or equal to 55 m²/g, or even greater than or equal to 60 m²/g. In embodiments, the metakaolin may have a surface area of from 10 m²/g to 100 m²/g. For instance, in embodiments, the metakaolin may have a surface area of from 20 m²/g to 100 m²/g, from 30 m²/g to 100 m²/g, from 40 m²/g to 100 m²/g, from 50 m²/g to 100 m²/g, from 60 m²/g to 100 m²/g, from 10 m²/g to 80 m²/g, from 20 m²/g to 80 m²/g, from 30 m²/g to 80 m²/g, from 40 m²/g to 80 m²/g, from 50 m²/g to 80 m²/g, or from 60 m²/g to 80 m²/g. The surface area is determined using BET analysis.

In embodiments, the metakaolin converted from the clay mineral compositions may have an average pore volume of greater than or equal to 0.15 cm³/g, such as greater than or equal to 0.20 cm³/g, greater than or equal to 0.25 cm³/g, or greater than or equal to 0.30 cm³/g. In embodiments, the metakaolin may have an average pore volume of from 0.1 cm³/g to 0.5 cm³/g. For instance, in embodiments, the metakaolin may have an average pore volume of from 0.2 cm³/g to 0.5 cm³/g, or from 0.3 cm³/g to 0.5 cm³/g. In embodiments, the metakaolin may have an average pore diameter of from 0.5 nm to 50 nm. The average pore volume and the average pore diameter are determined using BJH analysis.

Referring again to FIG. 2, as described herein, at step 220, the method may include synthesizing an intermediate ZSM-5 zeolite from the metakaolin, a silica source, and ZSM-5 zeolite seeds.

The ZSM-5 zeolite seeds may be active to catalytically crack hydrocarbon compounds. As used in the present disclosure, “ZSM-5” or “ZSM-5 zeolites” refers to zeolites having an MFI framework type according to the IUPAC zeolite nomenclature and consisting of silica and alumina. ZSM-5 refers to “Zeolite Socony Mobil-5” and is a pentasil family zeolite that can be represented by the chemical formula NaₙAlₙSi₉₆₋ₙO₁₉₂·16H₂O, where 0<n<27. The term “ZSM-5 zeolite seeds” refers to preformed ZSM-5 zeolites particles, which may be added to a slurry comprising the metakaolin and silica source to direct the formation of the intermediate ZSM-5 zeolite in the methods described in the present disclosure. In embodiments, the ZSM-5 zeolite seeds may have a silica to alumina weight ratio (SAR) of from 10 to 280, such as from 10 to 200, from 10 to 150, from 10 to 100, from 50 to 280, from 50 to 200, from 50 to 150, or from 50 to 100.

In embodiments, the ZSM-5 zeolite seeds may have a surface area of greater than or equal to 200 m²/g, such as greater than or equal to 250 m²/g, greater than or equal to 300 m²/g, or greater than or equal to 350 m²/g. In embodiments. The ZSM-5 zeolite seeds may have a surface area of from 200 m²/g to 500 m²/g, from 200 m²/g to 400 m²/g, from 200 m²/g to 375 m²/g, from 250 m²/g to 500 m²/g, from 250 m²/g to 400 m²/g, from 250 m²/g to 375 m²/g, from 300 m²/g to 500 m²/g, from 300 m²/g to 400 m²/g, from 300 m²/g to 375 m²/g, from 350 m²/g to 500 m²/g, from 350 m²/g to 400 m²/g, or from 350 m²/g to 375 m²/g. The surface area is determined using BET analysis.

In embodiments, the ZSM-5 zeolite seeds may have an average total pore volume of greater than or equal to 0.10 cm³/g, such as greater than or equal to 0.15 cm³/g, or greater than or equal to 0.20 cm³/g. In embodiments, the ZSM-5 zeolite seeds may have an average total pore volume of less than 0.35 cm³/g, less than 0.30 cm³/g, or less than 0.25 cm³/g. In embodiments, the ZSM-5 zeolite seeds may have an average total pore volume of from 0.1 cm³/g to 0.5 cm³/g. For instance, in embodiments, the ZSM-5 zeolite seeds may have an average total pore volume of from 0.1 cm³/g to 0.4 cm³/g, from 0.1 cm³/g to 0.3 cm³/g from 0.1 cm³/g to 0.25 cm³/g, from 0.15 cm³/g to 0.4 cm³/g, from 0.15 cm³/g to 0.3 cm³/g, from 0.15 cm³/g to 0.25 cm³/g, from 0.2 cm³/g to 0.4 cm³/g, from 0.2 cm³/g to 0.3 cm³/g, or from 0.2 cm³/g to 0.25 cm³/g. The average total pore volume is determined using BJH analysis.

In embodiments, the silica source may be any source comprising silica. In embodiments, the silica source may comprise colloidal silica, tetraethyl orthosilicate, or combinations thereof.

In embodiments, synthesizing the intermediate ZSM-5 zeolite may include forming a slurry comprising at least the metakaolin, the silica source, and the ZSM-5 zeolite seeds. In embodiments, the slurry may comprise of from 0.5 wt. % to 5 wt. % of the metakaolin, based on the total weight of the slurry. For instance, the slurry may comprise of from 0.5 wt. % to 5 wt. %, from 0.5 wt. % to 4 wt. %, from 0.5 wt. % to 3 wt. %, from 0.5 wt. % to 2 wt. %, from 0.5 wt. % to 1 wt. %, from 1 wt. % to 5 wt. %, from 1 wt. % to 4 wt. %, from 1 wt. % to 3 wt. %, from 1 wt. % to 2 wt. %, from 2 wt. % to 5 wt. %, from 2 wt. % to 4 wt. %, from 2 wt. % to 3 wt. %, from 3 wt. % to 5 wt. %, from 3 wt. % to 4 wt. %, or from 4 wt. % to 5 wt. % of the metakaolin, based on the total weight of the slurry.

In embodiments, the slurry may comprise of from 0.01 wt. % to 5 wt. % of the ZSM-5 zeolite seeds, based on the total weight of the slurry. For instance, the slurry may comprise from 0.01 wt. % to 5 wt. %, from 0.01 wt. % to 4 wt. %, from 0.01 wt. % to 3 wt. %, from 0.01 wt. % to 2 wt. %, from 0.01 wt. % to 1 wt. %, from 0.01 wt. % to 0.5 wt. %, from 0.01 wt. % to 0.2 wt. %, from 0.1 wt. % to 5 wt. %, from 0.1 wt. % to 4 wt. %, from 0.1 wt. % to 3 wt. %, from 0.1 wt. % to 2 wt. %, from 0.1 wt. % to 1 wt. %, from 0.5 wt. % to 5 wt. %, from 0.5 wt. % to 4 wt. %, from 0.5 wt. % to 3 wt. %, from 0.5 wt. % to 2 wt. %, from 0.5 wt. % to 1 wt. %, from 1 wt. % to 5 wt. %, from 1 wt. % to 4 wt. %, from 1 wt. % to 3 wt. %, from 1 wt. % to 2 wt. %, from 2 wt. % to 5 wt. %, from 2 wt. % to 4 wt. %, from 2 wt. % to 3 wt. %, from 3 wt. % to 5 wt. %, from 3 wt. % to 4 wt. %, or from 4 wt. % to 5 wt. % of the ZSM-5 zeolite seeds, based on the total weight of the slurry.

In embodiments, the slurry may comprise of from 5 wt. % to 60 wt. % of the silica source, based on the total weight of the slurry. For instance, the slurry may comprise from 5 wt. % to 50 wt. %, from 5 wt. % to 40 wt. %, from 5 wt. % to 30 wt. %, from 5 wt. % to 20 wt. %, from 10 wt. % to 60 wt. %, from 10 wt. % to 50 wt. %, from 10 wt. % to 40 wt. %, from 10 wt. % to 30 wt. %, from 10 wt. % to 20 wt. %, from 20 wt. % to 60 wt. %, from 20 wt. % to 50 wt. %, from 20 wt. % to 40 wt. %, from 20 wt. % to 30 wt. %, from 30 wt. % to 60 wt. %, from 30 wt. % to 50 wt. %, or from 35 wt. % to 45 wt. % of the silica source, based on the total weight of the slurry.

In embodiments, the slurry may comprise a templating agent. In embodiments, the templating agent may comprise an ammonium salt, such as but not limited to tetrapropylammonium bromide (TPABr), tetrapropylammonium hydroxide (TPAOH), or centrimonium bromide (CTAB). In embodiments, the ammonium salt may be a bromide salt. In embodiments. The templating agent may comprise a poloxamer, such as but not limited to Pluronic® F-127 and Pluronic® P-123, commercially available from BASF Corporation. As used herein, the term “poloxamer” may refer to a triblock copolymer comprising a central hydrophobic chain of poly(propylene oxide) and two hydrophilic chains of poly(ethylene oxide). In embodiments, the templating agent may comprise an ammonium salt, a poloxamer, or combinations thereof. In embodiments, the templating agent may be selected from an ammonium salt, a poloxamer, and combinations thereof.

In embodiments, the slurry may comprise of from 0 wt. % to 3 wt. % of the templating agent, based on the total weight of the slurry. For instance, the slurry may comprise from 0.5 wt. % to 3 wt. %, from 0.5 wt. % to 2 wt. %, from 0.5 wt. % to 1 wt. %, from 1 wt. % to 3 wt. %, from 1 wt. % to 2 wt. %, or from 2 wt. % to 3 wt. % of the templating agent, based on the total weight of the slurry. In embodiments, the slurry may not include the templating agent.

In embodiments, the slurry may comprise a basic compound. In embodiments, the basic compound may be any basic compound. In embodiments, the basic compound may comprise sodium hydroxide. In embodiments, the basic compound may comprise sodium carbonate. Without intending to be bound by any particular theory, it is believed that the basic compound may facilitate dissolution of the silica source in the slurry.

In embodiments, the slurry may comprise of from 0 wt. % to 4 wt. % of the basic compound, based on the total weight of the slurry. For instance, the slurry may comprise from 0.5 wt. % to 4 wt. %, from 0.5 wt. % to 3 wt. %, from 0.5 wt. % to 2 wt. %, from 0.5 wt. % to 1 wt. %, from 1 wt. % to 4 wt. %, from 1 wt. % to 3 wt. %, from 1 wt. % to 2 wt. %, from 2 wt. % to 4 wt. %, or from 2 wt. % to 3 wt. % of the basic compound, based on the total weight of the slurry. In embodiments the slurry may comprise from 0.5 wt. % to 4 wt. %, from 0.5 wt. % to 3 wt. %, from 0.5 wt. % to 2 wt. %, from 0.5 wt. % to 1 wt. %, from 1 wt. % to 4 wt. %, from 1 wt. % to 3 wt. %, from 1 wt. % to 2 wt. %, from 2 wt. % to 4 wt. %, or from 2 wt. % to 3 wt. % of NaOH, based on the total weight of the slurry.

The intermediate ZSM-5 zeolite is a shape selective zeolite that can be active to catalytically-crack hydrocarbons to produce smaller hydrocarbon molecules, such as the light olefins, light aromatic compounds, or both. The intermediate ZSM-5 zeolite can have a microporous pore structure with an average pore size of less than or equal to 2 nm. The intermediate ZSM-5 zeolite can have a molar ratio of silica to alumina of greater than or equal to 10 or greater than or equal to 20. The intermediate ZSM-5 zeolite can have a molar ratio of silica to alumina of less than or equal to 300, such as less than or equal to 200, less than or equal to 100, or even less than or equal to 40. In embodiments, the intermediate ZSM-5 zeolite can have a molar ratio of silica to alumina of from 10 to 300, from 10 to 200, from 10 to 100, from 10 to 50, from 20 to 300, from 20 to 200, from 20 to 100, from 20 to 50, or from 50 to 300. The intermediate ZSM-5 zeolite can be in the form of a plurality of particles, such as a plurality of spherical particles.

Referring again to FIG. 2, as described herein, at step 230, the method may include forming a cracking catalyst comprising a hierarchical mesoporous ZSM-5 zeolite through disintegration and recrystallization of the intermediate ZSM-5 zeolite.

The disintegration process may be carried out to disintegrate at least a portion of the intermediate ZSM-5 zeolite. As used in the present disclosure, the terms “disintegrate” and “disintegration” refer to breaking down the ZSM-5 framework structure into its constituent oxides, such as alumina and silica, which are then dissolved into solution. Disintegrating at least a portion of the intermediate ZSM-5 zeolite may comprise first combining the intermediate ZSM-5 zeolite, sodium hydroxide, and a surfactant to form the first mixture.

The first mixture may include a concentration of sodium hydroxide sufficient to breakdown the zeolite framework structure of portions of the intermediate ZSM-5 zeolite and dissolve the disintegrated alumina and silica into the first mixture. In embodiments, the first mixture may comprise a concentration of sodium hydroxide of from 0.2 molar (M) to 0.4 M. The surfactant may an ionic surfactant, such as cetyltrimethylammonium bromide (CTAB), cetylpyridinium chloride, or combinations thereof. In embodiments, the surfactant may be a non-ionic triblock copolymer, such as Pluronic® P123, Pluronic® F127, or combinations thereof. The first mixture may include an amount of the surfactant sufficient to solubilize the constituents of the intermediate ZSM-5 zeolite following disintegration of those constituents and control formation of the mesopores during the recrystallization process. In embodiments, the first mixture can include a concentration of CTAB of from 4 wt. % to 5 wt. %, or 4.45 wt. %, based on the total weight of the first mixture. The first mixture may have a pH greater than 9, greater than or equal to 10, greater than or equal to 10.5, or even greater than or equal to 11. The pH may be from 9.5 to 14, from 9.5 to 13, from 9.5 to 12.5, from 9.5 to 12, from 10 to 14, from 10 to 13, from 10 to 12.5, from 10 to 12, from 10.5 to 14, from 10.5 to 13, from 10.5 to 12.5, from 10.5 to 12, from 11 to 14, from 11 to 13, from 11 to 12.5, or even from 11 to 12.

In embodiments, other methods may be used to further generate mesopores in the intermediate ZSM-5 zeolite, such as but not limited to insertion of labile metals such as germanium and zirconium followed by removal of the labile metals via steam treatment. In embodiments, desilication and dealumination treatment may also be used to further generate mesopores in the intermediate ZSM-5 zeolite.

Disintegration may further comprise hydrothermally treating the first mixture, where hydrothermally treating the intermediate ZSM-5 zeolite in the presence of the sodium hydroxide and the surfactant causes the disintegration of portions of the intermediate ZSM-5 zeolite. Hydrothermally treating the first mixture may include heating the first mixture to a first hydrothermal treatment temperature of greater than or equal to 100° C., such as a temperature of from 100° C. to 150° C., while stirring the first mixture. Hydrothermally treating the first mixture may further include maintaining the first mixture under stirring at the temperature of greater than or equal to 100° C. or from 100° C. to 150° C. for a first hydrothermal treatment time. The first hydrothermal treatment time may be sufficient to disintegrate a portion but not all of the intermediate ZSM-5 zeolite. If the first hydrothermal treatment time is too long, all of the intermediate ZSM-5 zeolite may be disintegrated, which can make it difficult to initiate recrystallization of the zeolite constituents to form the hierarchical mesoporous ZSM-5 zeolite. If the first hydrothermal treatment time is too short, then insufficient disintegration of the ZSM-5 zeolite may lead to insufficient formation of mesopores in the hierarchical mesoporous ZSM-5 zeolite, which may limit the total BET surface area and decrease the number of accessible reaction sites. In embodiments, the first hydrothermal treatment time may be from 10 hours to 30 hours, such as from 10 hours to 24 hours, from 14 hours to 30 hours from 14 hours to 24 hours, from 18 hours to 30 hours, from 18 hours to 24 hours, from 20 hours to 30 hours, or about 24 hours.

Following disintegration of at least a portion of the intermediate ZSM-5 zeolite in the first mixture, the alumina and silica constituents disintegrated and dissolved into the first mixture may then be recrystallized in the presence of the surfactant to produce the hierarchical pore structure of the hierarchical mesoporous ZSM-5 zeolite of the present disclosure. Recrystallization of the alumina and silica constituents disintegrated from the intermediate ZSM-5 zeolite in the presence of the surfactant can enable the creation of the mesoporous structure while retaining the same silica to alumina molar ratio as the intermediate ZSM-5 zeolite.

Recrystallizing the alumina and silica constituents that have been disintegrated from the intermediate ZSM-5 zeolite may include cooling the first mixture back to room temperature. Cooling the first mixture may include cooling the first mixture to a temperature of from 20° C. to 50° C., such as to a temperature of 25° C. After cooling, the recrystallizing may include adjusting the pH of the first mixture to a pH of 9.0 to produce a second mixture. The pH may be adjusted by adding a strong acid, such as but not limited to sulfuric acid. In embodiments, the strong acid may be added to the first mixture dropwise until the pH reaches 9.0. In embodiments, the pH can be adjusting with a 2 normality (2N) sulfuric acid solution, where normality is the number of moles of reactive units (protons) per liter of the sulfuric acid solution. The second mixture comprises the portions of the intermediate ZSM-5 zeolite particles not disintegrated, the surfactant, and the silica and alumina species disintegrated and dissolved into the second mixture.

After adjusting the pH, recrystallizing the ZSM-5 constituents may include stirring the second mixture for a second time period of from 10 hours to 30 hours, from 10 hours to 24 hours, from 14 hours to 30 hours from 14 hours to 24 hours, from 18 hours to 30 hours, from 18 hours to 24 hours, from 20 hours to 30 hours, or about 24 hours, and then hydrothermally treating the second mixture. Hydrothermally treating the second mixture can include heating the second mixture to a second hydrothermal treatment temperature of greater than or equal to 100° C., such as from 100° C. to 150° C., and maintaining the second mixture at the second hydrothermal treatment temperature under stirring for a third time period. The third time period may be sufficient to recrystallize the silica and alumina constituents of the ZSM-5 zeolite in the presence of the surfactant to produce the recrystallized ZSM-5 zeolite having a mesoporous structure of the recrystallized portion. In embodiments, the third time period can be from 10 hours to 30 hours, from 10 hours to 24 hours, from 14 hours to 30 hours from 14 hours to 24 hours, from 18 hours to 30 hours, from 18 hours to 24 hours, from 20 hours to 30 hours, or about 24 hours. Stirring the second mixture for the second time period and hydrothermally treating the second mixture for the third time period recrystallizes the alumina and silica constituents in the presence of the surfactant to produce the recrystallized ZSM-5 zeolite. In particular, during recrystallization, the alumina and silica constituents in the second mixture may recrystallize in the presence of the surfactant to form a layer of ZSM-5 zeolite having a hierarchical porous structure onto the outer surfaces of the non-disintegrated portions of the intermediate ZSM-5 zeolite. The hierarchical porous structure of the layer of ZSM-5 zeolite recrystallized on the surfaces of the non-disintegrated portion of the intermediate ZSM-5 zeolite can include mesopores and micropores.

Following recrystallization, producing the hierarchical mesoporous ZSM-5 zeolite may include recovering the recrystallized ZSM-5 zeolite. Recovering the recrystallized ZSM-5 zeolite may include separating the recrystallized ZSM-5 zeolite particles from the second mixture, such as but not limited to filtering the second mixture to produce a filtrate comprising the recrystallized ZSM-5 zeolite particles. Other solid-liquid separation processes can be used in addition to or in place of filtration. Following separation of the recrystallized ZSM-5 zeolite particles from the second mixture, the recrystallized ZSM-5 zeolite particles can be washed with water, such as distilled water or deionized water, to remove residual reagents of the second mixture from the surfaces and pores of the recrystallized ZSM-5 particles. After washing, recrystallized ZSM-5 zeolite particles can be dried at a drying temperature of 80° C. for a drying period of from 8 hours to 24 hours to produce a recrystallized ZSM-5 zeolite powder. The recrystallized ZSM-5 zeolite powder may then be calcined at a temperature of from 500° C. to 800° C. for a calcination period of from 5 hours to 24 hours to produce the hierarchical mesoporous ZSM-5 zeolite having the hierarchical pore structure.

In embodiments, the hierarchical mesoporous ZSM-5 zeolite can be ion-exchanged to produce the hydrogen form of the hierarchical mesoporous ZSM-5 zeolite. In hydrogen form, the Brønsted acid sites in the zeolite, also known as bridging OH—H groups, may form hydrogen bonds with other framework oxygen atoms in the zeolite framework. In embodiments, the method of producing the hierarchical mesoporous ZSM-5 zeolite may include ion-exchanging the hierarchical mesoporous ZSM-5 zeolite to produce the hydrogen form of the hierarchical mesoporous ZSM-5 zeolite. In embodiments, ion-exchanging the hierarchical mesoporous ZSM-5 zeolite may include treating the hierarchical mesoporous ZSM-5 zeolite with 0.25 normal (N) ammonium nitrate at 80° C. for 5 hours. In embodiments, the ion-exchanging process may be conducted a plurality of times, such as by treating the hierarchical mesoporous ZSM-5 zeolite with 0.25 N ammonium nitrate two times or more than two times at 80° C. for 5 hours each time. In embodiments, the hierarchical mesoporous ZSM-5 zeolite may be in hydrogen form.

The hierarchical mesoporous ZSM-5 zeolite can have a molar ratio of silica to alumina of greater than or equal to 10 or greater than or equal to 20. The hierarchical mesoporous ZSM-5 zeolite can have a molar ratio of silica to alumina of less than or equal to 300, such as less than or equal to 200, less than or equal to 100, or even less than or equal to 40. In embodiments, the hierarchical mesoporous ZSM-5 zeolite can have a molar ratio of silica to alumina of from 10 to 300, such as from 10 to 200, from 10 to 100, from 10 to 50, from 20 to 300, from 20 to 200, from 20 to 100, from 20 to 50, or from 50 to 300. In embodiments, the hierarchical mesoporous ZSM-5 zeolite can have a molar ratio of silica to alumina that is the same as the molar ratio of silica to alumina of the intermediate ZSM-5 zeolite.

The hierarchical mesoporous ZSM-5 zeolite may be in the form of a plurality of particles. In embodiments, the hierarchical mesoporous ZSM-5 zeolite may have an average crystal size of greater than or equal to 50 nm, greater than or equal to 100 nm, or even greater than or equal to 200 nm. The hierarchical mesoporous ZSM-5 zeolite may have an average crystal size of less than or equal to 600 nm or less than or equal to 500 nm. In embodiments, the hierarchical mesoporous ZSM-5 zeolite may have an average crystal size of from 50 nm to 600 nm, from 50 nm to 500 nm, from 100 nm to 600 nm, from 100 nm to 500 nm, from 200 nm to 600 nm, or from 200 nm to 500 nm. The average crystal size is determined by scanning electron microscopy (SEM) according to known methods.

As previously discussed, the hierarchical mesoporous ZSM-5 zeolite of the cracking catalyst of the present disclosure has a hierarchical pore structure comprising mesopores and micropores. Not intending to be limited by any particular theory, it is believed that the presence of the mesopores created by the surfactant assisted disintegration and recrystallization may produce a mesoporous structure that can increase the adsorption of larger hydrocarbon molecules from the hydrocarbon feed 102 into the zeolite pore structure, leading to enhanced conversion. The presence of mesopores in the crystalline framework of the hierarchical mesoporous ZSM-5 zeolites may be considered to be equivalent to increasing its external surface area, making a larger number of pore openings accessible to larger reactants, such as greater molecular weight hydrocarbon molecules. The mesopores may act as highways to facilitate molecular transport to and from the micropores, which harbor the active reaction sites. The creation of the mesopores in the hierarchical mesoporous ZSM-5 zeolite may also shorten the diffusion path length in the micropores leading to an improved transport and thus a more efficient use of ZSM-5 as a catalyst. The shortened diffusion path length means that target products, like light olefins, may be less susceptible to secondary reactions like hydrogenation or oligomerization. Increased molecular transport within the hierarchical mesoporous ZSM-5 zeolite of the present disclosure may reduce the probability of pore mouth coke formation and may increases the lifetime of the catalyst. The pore mouth coke formation is believed to be a result of clogging of heavy aromatics compounds form the hydrocarbon feed 102, which are restricted from entering into surface pores of microporous zeolites zeolite at higher temperatures.

In embodiments, the hierarchical mesoporous ZSM-5 zeolite may have a specific surface area of from 300 m²/g to 700 m²/g. For instance, in embodiments, the hierarchical mesoporous ZSM-5 zeolite may have a specific surface area of from 300 m²/g to 700 m²/g, from 400 m²/g to 700 m²/g, from 450 m²/g to 700 m²/g, from 300 m²/g to 600 m²/g, from 400 m²/g to 600 m²/g, or from 450 m²/g to 600 m²/g. In embodiments, the hierarchical mesoporous ZSM-5 zeolite may have a specific surface area of from 300 m²/g to 700 m²/g, from 400 m²/g to 700 m²/g, from 450 m²/g to 700 m²/g, from 300 m²/g to 600 m²/g, from 400 m²/g to 600 m²/g, or from 450 m²/g to 600 m²/g prior to impregnation with manganese, zirconium, or manganese and zirconium. The specific surface area is determined according to the Brunauer-Emmett-Teller (BET) method. The specific surface area may be referred to throughout the present disclosure as the total BET surface area. The total BET surface area of the hierarchical mesoporous ZSM-5 zeolite can include the BET surface area provided by the mesoporous structure and the BET surface area provided by the microporous structure. The BET surface area provided by the mesopores is referred to throughout the present disclosure as the mesoporous BET surface area, which represents the surface area of internal surfaces of mesopores of the hierarchical mesoporous ZSM-5 zeolite as determined by the BET method. The BET surface area provided by the micropores is referred to throughout the present disclosure as the microporous BET surface area, which represents the surface area of internal surface of micropores of the hierarchical mesoporous ZSM-5 zeolite as determined by the BET method.

The hierarchical mesoporous ZSM-5 zeolite may have a mesoporous BET surface area that is greater than a microporous BET surface area of the hierarchical mesoporous ZSM-5 zeolite. In embodiments, the mesoporous BET surface area of the hierarchical mesoporous ZSM-5 zeolite may be greater than 50% of the total BET surface area of the hierarchical mesoporous ZSM-5 zeolite, such as greater than or equal to 52%, or even greater than or equal to 55% of the total BET surface area of the hierarchical mesoporous ZSM-5 zeolite. In embodiments, the mesoporous BET surface area of the hierarchical mesoporous ZSM-5 zeolite may be from 50% to 80%, from 50% to 75%, from 50% to 70%, from 50% to 65%, from 50% to 60%, from 52% to 80%, from 52% to 75%, from 52% to 70%, from 52% to 65%, from 52% to 60%, from 55% to 80%, from 55% to 75%, from 55% to 70%, from 55% to 65%, or from 55% to 60% of the total BET surface area of the hierarchical mesoporous ZSM-5 zeolite. The balance of the total BET surface area can be the microporous BET surface area. In embodiments, the hierarchical mesoporous ZSM-5 zeolite may have a mesoporous BET surface area of from 250 m²/g to 400 m²/g, such as from 300 m²/g to 400 m²/g, or from 300 m²/g to 350 m²/g. In embodiments, the hierarchical mesoporous ZSM-5 zeolite may have a mesoporous BET surface area of from 250 m²/g to 600 m²/g, such as from 300 m²/g to 600 m²/g, from 325 m²/g to 600 m²/g, from 350 m²/g to 600 m²/g, from 250 m²/g to 400 m²/g, from 250 m²/g to 350 m²/g, from 250 m²/g to 325 m²/g, from 250 m²/g to 300 m²/g, from 300 m²/g to 600 m²/g, from 300 m²/g to 400 m²/g, from 300 m²/g to 350 m²/g, or from 300 m²/g to 325 m²/g prior to impregnation with the manganese, zirconium, or both the manganese and zirconium compounds.

The hierarchical mesoporous ZSM-5 zeolite may have a total pore volume of from 0.35 centimeter squared per gram (cm³/g) to 0.50 cm³/g, such as from 0.35 cm³/g to 0.45 cm³/g, from 0.40 cm³/g to 0.45 cm³/g, or from 0.40 cm³/g to 0.45 cm³/g. The hierarchical mesoporous ZSM-5 zeolite may have a total pore volume of from 0.40 centimeter squared per gram (cm³/g) to 0.50 cm³/g, or about 0.45 cm³/g prior to impregnation with manganese, zirconium, or manganese and zirconium. The total pore volume is determined from measured gas adsorption isotherms through Non-Local Density Functional Theory (NLDFT) modeling and analysis. The BET method is also used to determine the total pore volume. The total pore volume of the hierarchical mesoporous ZSM-5 zeolite includes the pore volume provided by the mesopores and the pore volume provided by the micropores. The pore volume provided by the mesopores is referred to throughout the present disclosure as the mesopore volume, and the pore volume provided by the micropores is referred to throughout the present disclosure as the micropore volume.

The hierarchical mesoporous ZSM-5 zeolite may have a mesopore volume that is greater than a micropore volume of the hierarchical mesoporous ZSM-5 zeolite. In embodiments, the mesopore volume of the hierarchical mesoporous ZSM-5 zeolite may be greater than 50% of the total pore volume of the hierarchical mesoporous ZSM-5 zeolite, such as greater than or equal to 60%, greater than or equal to 65%, or about 67% of the total pore volume of the hierarchical mesoporous ZSM-5 zeolite. In embodiments, the mesopore volume of the hierarchical mesoporous ZSM-5 zeolite may be from 60% to 80%, from 60% to 75%, from 60% to 70%, from 65% to 80%, from 65% to 75%, from 65% to 70%, from 67% to 80%, or from 67% to 75% of the total pore volume of the hierarchical mesoporous ZSM-5 zeolite. The remainder of the total pore volume may be the micropore volume. In embodiments, the hierarchical mesoporous ZSM-5 zeolite may have a mesopore volume of from 0.25 cm³/g to 0.50 cm³/g, from 0.30 cm³/g to 0.50 cm³/g, from 0.35 cm³/g to 0.50 cm³/g, from 0.25 cm³/g to 0.40 cm³/g, from 0.30 cm³/g to 0.40 cm³/g, from 0.35 cm³/g to 0.40 cm³/g, or from 0.30 cm³/g to 0.35 cm³/g. In embodiments, the hierarchical mesoporous ZSM-5 zeolite may have a mesopore volume of from 0.25 cm³/g to 0.50 cm³/g, from 0.30 cm³/g to 0.50 cm³/g, from 0.35 cm³/g to 0.50 cm³/g, from 0.25 cm³/g to 0.40 cm³/g, from 0.30 cm³/g to 0.40 cm³/g, from 0.35 cm³/g to 0.40 cm³/g, or from 0.30 cm³/g to 0.35 cm³/g prior to impregnation with the manganese, zirconium, or both manganese and zirconium.

Following synthesis of the hierarchical mesoporous ZSM-5 zeolite, the method of preparing the cracking catalyst of the present disclosure may include impregnating the hierarchical mesoporous ZSM-5 zeolite with manganese, zirconium, or manganese and zirconium. The cracking catalyst may further include manganese, manganese-containing compounds, zirconium, zirconium-containing compounds, or combinations of these compounds impregnated onto the outer surfaces and pore surfaces of the hierarchical mesoporous ZSM-5 zeolite. The manganese, manganese-containing compounds, zirconium, or zirconium-containing compounds may be supported by the hierarchical mesoporous ZSM-5 zeolite. Not intending to be bound by any particular theory, it is believed that including manganese, manganese-containing compounds, zirconium, or zirconium-containing compounds in the cracking catalyst can improve the thermal stability of the hierarchical mesoporous ZSM-5 zeolite. In embodiments, the manganese-containing compounds may include manganese oxide, such as MnO, Mn₂O₃, MnO₂, MnO₃, or Mn₂O₇. In embodiments, the zirconium-containing compounds may include zirconium oxide, such as ZrO₂. The manganese, manganese oxide, zirconium, or zirconium oxide may be disposed at or deposited on the outer surfaces, the pore surfaces, or both of the hierarchical mesoporous ZSM-5 zeolite so that the manganese, manganese oxide, zirconium, or zirconium oxide is accessible to reactants that come into contact with the cracking catalyst or diffuse into the pores of the cracking catalyst. The manganese, manganese oxide, zirconium, or zirconium oxide can be deposited on the hierarchical mesoporous ZSM-5 zeolite through known methods, such as but not limited to wet impregnation methods, incipient wetness impregnation methods, or other impregnation methods.

The cracking catalyst can include an amount of the manganese or manganese-containing compounds, such as manganese oxide, sufficient to improve the thermal stability of the cracking catalyst. In embodiments, the cracking catalyst may comprise from 1 wt. % to 5 wt. % manganese, manganese-containing compounds, or both based on the total weight of the cracking catalyst. In embodiments, the cracking catalyst may comprise from 1 wt. % to 4.5 wt. %, from 1 wt. % to 4 wt. %, from 1 wt. % to 3.5 wt. %, from 1 wt. % to 3 wt. %, from 1 wt. % to 2.5 wt. %, from 1 wt. % to 2 wt. %, from 1 wt. % to 1.5 wt. %, from 1.5 wt. % to 5 wt. %, from 2 wt. % to 5 wt. %, from 2.5 wt. % to 5 wt. %, from 3 wt. % to 5 wt. %, from 3.5 wt. % to 5 wt. %, from 4 wt. % to 5 wt. %, from 4.5 wt. % to 5 wt. %, from 1.5 wt. % to 4.5 wt. %, from 2 wt. % to 4 wt. %, or from 2.5 wt. % to 4 wt. % manganese, manganese-containing compounds, or both based on the total weight of the cracking catalyst.

The cracking catalyst can include an amount of the zirconium or zirconium-containing compounds, such as zirconium oxide, sufficient to improve the thermal stability of the cracking catalyst. In embodiments, the cracking catalyst may comprise from 1 wt. % to 5 wt. % zirconium, zirconium-containing compounds, or both based on the total weight of the cracking catalyst. In embodiments, the cracking catalyst may comprise from 1 wt. % to 4.5 wt. %, from 1 wt. % to 4 wt. %, from 1 wt. % to 3.5 wt. %, from 1 wt. % to 3 wt. %, from 1 wt. % to 2.5 wt. %, from 1 wt. % to 2 wt. %, from 1 wt. % to 1.5 wt. %, from 1.5 wt. % to 5 wt. %, from 2 wt. % to 5 wt. %, from 2.5 wt. % to 5 wt. %, from 3 wt. % to 5 wt. %, from 3.5 wt. % to 5 wt. %, from 4 wt. % to 5 wt. %, from 4.5 wt. % to 5 wt. %, from 1.5 wt. % to 4.5 wt. %, from 2 wt. % to 4 wt. %, or from 2.5 wt. % to 4 wt. % zirconium, zirconium-containing compounds, or both based on the total weight of the cracking catalyst.

In embodiments, the cracking catalyst may comprise, consist of, or consist essentially of the hierarchical mesoporous ZSM-5 zeolite and from 1 wt. % to 5 wt. % of one or more of manganese, manganese-containing compounds, zirconium, zirconium-containing compounds, or combinations of these impregnated onto the hierarchical mesoporous ZSM-5 zeolite, where the weight percentage is based on the total weight of the cracking catalyst. In embodiments, the cracking catalyst may comprise, consist of, or consist essentially of the hierarchical mesoporous ZSM-5 zeolite impregnated with from 1 wt. % to 5 wt. % manganese oxide, based on the total weight of the cracking catalyst. In embodiments, the cracking catalyst may comprise, consist of, or consist essentially of the hierarchical mesoporous ZSM-5 zeolite impregnated with from 1 wt. % to 5 wt. % zirconium oxide, based on the total weight of the cracking catalyst. In embodiments, the cracking catalyst may comprise, consist of, or consist essentially of the hierarchical mesoporous ZSM-5 zeolite impregnated with from 1 wt. % to 5 wt. % manganese oxide and from 1 wt. % to 5 wt. % zirconium oxide, based on the total weight of the cracking catalyst.

In embodiments, the cracking catalyst may comprise, consist of, or consist essentially of the hierarchical mesoporous ZSM-5 zeolite, a beta zeolite, and from 1 wt. % to 5 wt. % of one or more of manganese, manganese-containing compounds, zirconium, zirconium-containing compounds, or combinations of these impregnated onto the hierarchical mesoporous ZSM-5 zeolite, where the weight percentage is based on the total weight of the cracking catalyst. In embodiments, the cracking catalyst may comprise, consist of, or consist essentially of the hierarchical mesoporous ZSM-5 zeolite, a beta zeolite, from 1 wt. % to 5 wt. % of one or more of manganese, manganese-containing compounds, zirconium, zirconium-containing compounds, or combinations of these impregnated onto the hierarchical mesoporous ZSM-5 zeolite, where the weight percentage is based on the total weight of the cracking catalyst, and from 1 wt. % to 5 wt. % of one or more of manganese, manganese-containing compounds, zirconium, zirconium-containing compounds, or combinations of these impregnated onto the beta zeolite, where the weight percentage is based on the total weight of the cracking catalyst. In embodiments, the cracking catalyst may be prepared by preparing the hierarchical mesoporous ZSM-5 zeolite according to the methods disclosed herein; preparing a catalyst blend comprising the hierarchical mesoporous ZSM-5 zeolite and a beta zeolite; and impregnating the catalyst blend with from 1 wt. % to 5 wt. % of one or more of manganese, manganese-containing compounds, zirconium, zirconium-containing compounds, or combinations of these. In embodiments, the cracking catalyst may comprise a weight ratio of the hierarchical mesoporous ZSM-5 zeolite to the beta zeolite of from 20:1 to 1:5, such as from 10:1 to 1:1, from 5:1 to 1:1, or from 3:1 to 1:1.

As previously discussed, the cracking catalyst of the present disclosure can be used to convert hydrocarbons in crude oil to greater value petrochemical products and intermediates, such as light olefins, light aromatic compounds, or both, through steam enhanced catalytic cracking. Referring again to FIG. 1, the steam catalytic cracking effluent 140 produced through steam enhanced catalytic cracking may have an increased yield of light olefins, such as ethylene, propylene, and mixed butenes compared to effluents produced using conventional commercially available cracking catalysts.

Referring again to FIG. 1, the steam catalytic cracking system 110 may further include a cracking effluent separation system 150 disposed downstream of the steam catalytic cracking reactors 130. When the steam catalytic cracking system 110 includes a plurality of steam catalytic cracking reactors 130, the steam catalytic cracking effluents 140 from each of the steam catalytic cracking reactors 130 may be passed to a single shared cracking effluent separation system 150. In embodiments, each steam catalytic cracking reactor 130 may have its own dedicated cracking effluent separation system 130. The steam catalytic cracking effluent 140 may be passed from the steam catalytic cracking reactor 130 directly to the cracking effluent separation system 150. The cracking effluent separation system 150 may separate the steam catalytic cracking effluent 140 into one or more than one cracking product effluents, which may be liquid or gaseous product effluents.

Referring again to FIG. 1, the cracking effluent separation system 150 may include one or a plurality of separation units. Separation units may include but are not limited to distillation columns, fractionators, flash drums, knock-out drums, knock-out pots, centrifuges, decanters, filtration devices, traps, scrubbers, expansion devices, membranes, solvent extraction devices, adsorption devices, chemical separators, crystallizers, chromatographs, precipitators, evaporators, driers, high-pressure separators, low-pressure separators, or combinations or these. The separation units may include one or more gas-liquid separators, one or more liquid-liquid separators, or a combination of these.

In embodiments, the cracking effluent separation system 150 may include a gas-liquid separation unit 160 and a centrifuge unit 170 downstream of the gas-liquid separation unit 160. The gas-liquid separation unit 160 may operate to separate the steam catalytic cracking effluent 140 into a liquid effluent 162 and a gaseous effluent 164. The gas-liquid separation unit 160 may operate to reduce the temperature of the steam catalytic cracking effluent 140 to condense constituents of the steam catalytic cracking effluent 140 having greater than or equal to 5 carbon atoms. The gas-liquid separation unit 160 may operate at a temperature of from 10° C. to 15° C. to ensure that normal pentane and constituents with boiling point temperatures greater than normal pentane are condensed into the liquid effluent 162. The liquid effluent 162 may include distillation fractions such as naphtha, kerosene, gas oil, vacuum gas oil; unconverted feedstock; residue; water; or combinations of these. The liquid effluent 162 may include the light aromatic compounds produced in the steam catalytic cracking reactor 130, which light aromatic compounds may include but are not limited to benzene, toluene, mixed xylenes, ethylbenzene, and other light aromatic compounds. The liquid effluent 162 may include at least 95%, at least 98%, at least 99%, or even at least 99.5% of the hydrocarbon constituents of the steam catalytic cracking effluent 140 having greater than or equal to 5 carbon atoms. The liquid effluent 162 may include at least 95%, at least 98%, at least 99%, or even at least 99.5% of the water from of the steam catalytic cracking effluent 140. The liquid effluent 162 may be a two-phase stream comprising an oil phase and an aqueous phase immiscible with the oil phase.

The gaseous effluent 164 may include olefins, such as ethylene, propylene, butenes, or combinations of these; light hydrocarbon gases, such as methane, ethane, propane, n-butane, i-butane, or combinations of these; other gases, such as but not limited to hydrogen; or combinations of these. The gaseous effluent 164 may include the C₂-C₄ olefin products, such as but not limited to, ethylene, propylene, butenes (1-butene, cis-2-butene, trans-2-butene, isobutene, or combinations of these), or combinations of these, produced in the steam catalytic cracking reactor 130. The gaseous effluent 164 may include at least 90%, at least 95%, at least 98%, at least 99%, or at least 99.5% of the C₂-C₄ olefins from the steam catalytic cracking effluent 140. The gaseous effluent 164 may be passed to a downstream gas separation system (not shown) for further separation of the gaseous effluent 164 into various product streams, such as but not limited to one or more olefin product streams.

The liquid effluent 162 may be a two-phase stream comprising an oil phase and an aqueous phase immiscible with the oil phase. In embodiments, the liquid effluent 162, which includes the water and hydrocarbon having greater than 5 carbon atoms, may be passed to the in-line centrifuge unit 170. The in-line centrifuge unit 170 may operate to separate the liquid effluent 162 into a liquid hydrocarbon effluent 172 and an aqueous effluent 174. The in-line centrifuge unit 170 may be operated at a rotational speed of from 2500 rpm to 5000 rpm, from 2500 rpm to 4500 rpm, from 2500 rpm to 4000 rpm, from 3000 rpm to 5000 rpm, from 3000 rpm to 4500 rpm, or from 3000 rpm to 4000 rpm to separate the hydrocarbon phase from the aqueous phase.

The liquid hydrocarbon effluent 172 may include hydrocarbons from the steam catalytic cracking effluent 140 having greater than or equal to 5 carbon atoms. The liquid hydrocarbon effluent 172 may include the light aromatic compounds produced in the steam catalytic cracking reactor 130, which light aromatic compounds may include but are not limited to benzene, toluene, mixed xylenes, ethylbenzene, and other light aromatic compounds. The liquid hydrocarbon effluent 172 may further include naphtha, kerosene, diesel, vacuum gas oil (VGO), or combinations of these. The liquid hydrocarbon effluent 172 may include at least 90%, at least 95%, at least 98%, at least 99%, or even at least 99.5% of the hydrocarbon constituents from the liquid effluent 162. The liquid hydrocarbon effluent 172 may be passed to a downstream treatment processes for further conversion or separation. At least a portion of the liquid hydrocarbon effluent 172 may be passed back to the steam catalytic cracking reactor 130 for further conversion to olefins. The aqueous effluent 174 may include water and water soluble constituents from the liquid effluent 162. The aqueous effluent 174 may include some dissolved hydrocarbons soluble in the aqueous phase of the liquid effluent 162. The aqueous effluent 174 may include at least 95%, at least 98%, at least 99%, or even at least 99.5% of the water from the liquid effluent 162. The aqueous effluent 174 may be passed to one or more downstream processes for further treatment. In embodiments, at least a portion of the aqueous effluent 174 may be passed back to the steam catalytic cracking reactor 130 as at least a portion of the water 120 introduced to the steam catalytic cracking reactor 130.

In embodiments, the cracking catalyst produced by previously described processes may be used as a catalyst in a fluidized catalytic cracking (FCC) reactor. The FCC reactor may be a fluidized bed reactor. In the FCC reactor, the cracking catalyst consisting of the hierarchical mesoporous ZSM-5 zeolite and one or more of manganese, manganese-containing compounds, zirconium, zirconium-containing compounds, or combinations of these impregnated onto the hierarchical mesoporous ZSM-5 zeolite may be contacted with the hydrocarbon feed, such as crude oil, in the presence of steam to produce light olefins, light aromatic compounds, or combinations of these. In embodiments, the cracking catalyst consists of the hierarchical mesoporous ZSM-5 zeolite and one or more of manganese, manganese-containing compounds, zirconium, zirconium-containing compounds, or combinations of these impregnated onto the hierarchical mesoporous ZSM-5 zeolite. Suitable FCC processes for catalytically cracking crude oil in the presence of steam are disclosed in U.S. patent application Ser. No. 17/009,008, U.S. patent application Ser. No. 17/009,012, U.S. patent application Ser. No. 17/009,020, U.S. patent application Ser. No. 17/009,022, U.S. patent application Ser. No. 17/009,039, U.S. patent application Ser. No. 17/009,048, and U.S. patent application Ser. No. 17/009,073, all of which are incorporated by reference in their entireties in the present disclosure. The hydrocarbon feed can be any of the hydrocarbon feeds previously discussed in the present disclosure. The FCC reactor may be an upflow or a downflow FCC reactor. The FCC reactor system can include one or a plurality of FCC reactors, with one or a plurality of catalyst regenerators.

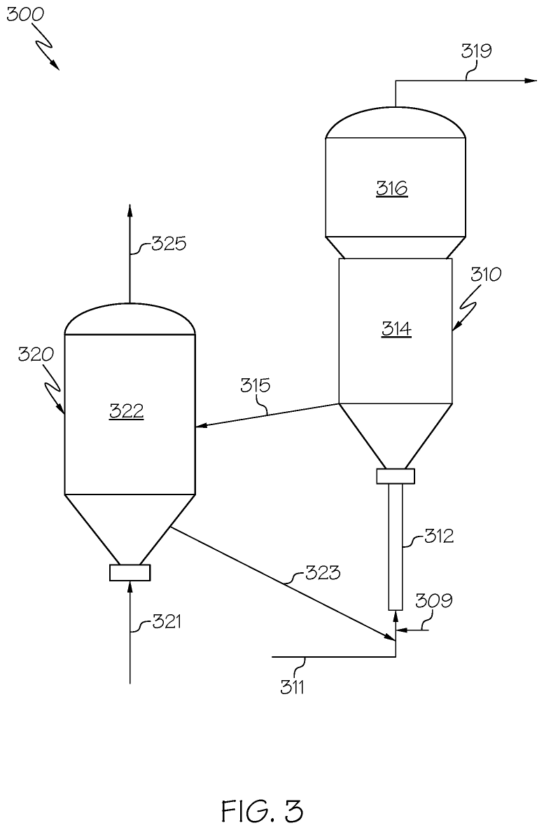

Referring now to FIG. 3, one embodiment of an FCC reactor system 300 that includes a riser FCC reactor is schematically depicted. The FCC reactor system 300 may comprise an upflow FCC reactor 310 and a catalyst regeneration unit 320. As used in the present disclosure in the context of FIG. 3, the upflow FCC reactor 310 refers to the portion of the FCC reactor system 300 in which the major process reaction takes place, such as steam enhanced fluidized catalytic cracking to convert hydrocarbons to light olefins, aromatic compounds, or both. The upflow FCC reactor 310 can include a riser 312, a reaction zone 314 downstream of the riser 312, and a separation zone 316 downstream of the reaction zone 314. The FCC reactor system 300 can also include a regeneration zone 322 in the regeneration unit 320 for regenerating spent FCC catalyst.

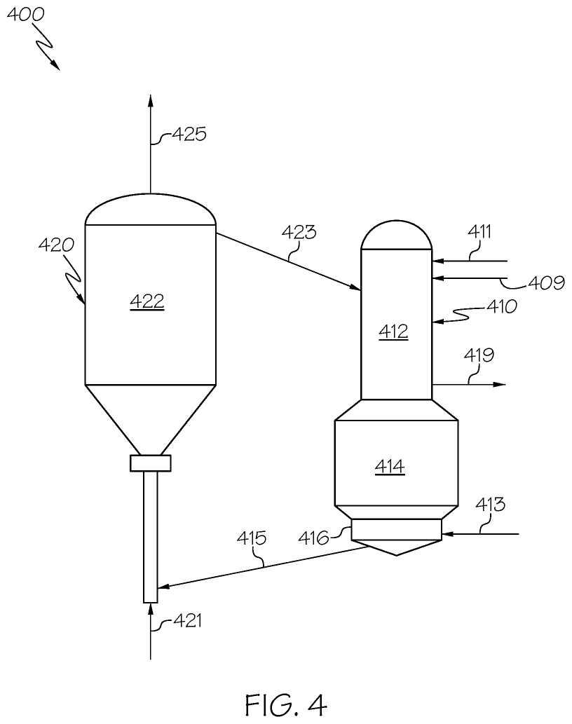

In operation of the FCC reactor system 300 of FIG. 3, the hydrocarbon feed 311 is introduced to the riser 312. In embodiments, the hydrocarbon feed 311 may be combined with steam 309. The hydrocarbon feed 311 may be combined with an effective quantity of heated fresh or regenerated FCC catalyst in the riser 312. With respect to FIGS. 3 and 4, the term FCC catalyst refers to a cracking catalyst that includes the hierarchical mesoporous ZSM-5 zeolite and one or more of manganese, manganese-containing compounds, zirconium, zirconium-containing compounds, or combinations of these impregnated onto the hierarchical mesoporous ZSM-5 zeolite. The heated fresh or regenerated FCC catalyst particles may comprise the cracking catalyst of the present disclosure and may have any of the features, compositions, or properties previously described in the present disclosure for the cracking catalyst. The heated fresh or regenerated FCC catalyst particles can be conveyed via a conduit 323 from the regeneration zone 322 to the riser 312. The hydrocarbon feed 311, the steam 309, and the FCC catalyst particles are contacted in the riser 312 and passed upward through the riser 312 into the reaction zone 314. In the riser 312 and the reaction zone 314, the hydrocarbons from the hydrocarbon feed 311 are contacted with the steam 309 in the presence of the FCC catalyst particles at reaction conditions. Contact of the hydrocarbons from the hydrocarbon feed 311 with the steam 309 and the FCC catalyst at the reaction conditions may cause at least a portion of the hydrocarbons to undergo one or more chemical reactions to form upgraded hydrocarbons, which can include light aromatic compounds, light olefins such as but not limited to ethylene, propylene, mixed butenes, or combinations of these.

The reaction mixture comprising the spent FCC catalyst particles, reaction products, and unreacted hydrocarbons are passed to the separation zone 316 downstream of the reaction zone 314. In the separation zone 316, the reaction products and unreacted hydrocarbons are separated from the spent FCC catalyst particles using any suitable configuration known in the art. The reaction products, unreacted hydrocarbons, and other gases separated from the spent FCC catalyst particles can be withdrawn from the separation zone 316 via conduit 319. During the reaction, the cracking catalyst composition particles can become coked, and the coke deposits can reduce access to the active catalytic sites on the spent FCC catalyst particles. The spent FCC catalyst particles containing coke deposits from the reaction can be passed through conduit 315 to the regeneration zone 322 of the regenerator 320. In the regeneration zone 322 of the regenerator 320, the coked FCC catalyst particles may come into contact with a stream of oxygen-containing gas, which may enter the regeneration zone 322 via conduit 321. Contact with the oxygen-containing gas causes the coke deposits to undergo combustion, which removes the coke deposits from and heats the FCC catalyst particles. The hot regenerated FCC catalyst particles may be transferred from the regeneration zone 322 of the catalyst regeneration unit 320 via conduit 323 to the bottom portion of the riser 312 for admixture with the hydrocarbon feed 311.

Referring now to FIG. 4, another embodiment of an FCC reactor system 400 is schematically depicted. The FCC reactor system 400 may include a downflow FCC reactor 410 and a catalyst regeneration unit 420. The downflow FCC reactor 410 generally refers to the unit of the reactor system 400 in which the major process reaction takes place, such as steam enhanced fluidized catalytic cracking. The downflow FCC reactor 410 can include a reaction zone 412, a separation zone 414, and a stripper zone 416. The reactor system 400 of FIG. 4 may also include a regeneration zone 422 in the regeneration unit 420 for regenerating the spent catalyst.

The hydrocarbon feed 411 and steam 409 may be introduced to the reaction zone 412. The heated fresh or regenerated FCC catalyst particles may be conveyed from the regeneration zone 422 to the top of the reaction zone 412 through a downwardly directed conduit 423 to a hopper (not shown) at the top of the reaction zone 412. The flow of hot FCC catalyst particles may be allowed to stabilize in order to uniformly direct the FCC catalyst particles into the mix zone or feed injection portion of the reaction zone 412. The hydrocarbon feed 411 can be injected into a mixing zone at the top of the reaction zone 412 through feed injection nozzles typically situated proximate to the point of introduction of the regenerated FCC catalyst particles into reaction zone 412. The multiple injection nozzles can cause the FCC catalyst particles, hydrocarbon feed 411, and steam 409 to mix thoroughly and uniformly. Once the hydrocarbon feed 411 contacts the hot FCC catalyst particles, a catalytic reaction may begin.

The hydrocarbon feed 411, steam 409, and FCC catalyst particles may travel generally downwards through the reaction zone 412. At the end of the reaction zone 412, the reaction vapors (reaction products, unconverted hydrocarbon feed, and carrier gases) and spent FCC catalyst particles may pass into the separation zone 414 downstream of the reaction zone 412. In the separation zone 414, the spent FCC catalyst particles are separated from the reaction vapors, which include reaction products and unreacted hydrocarbons from the hydrocarbon feed 411. The reaction vapors can be directed through conduit 419 to various product recovery unit operations. The reaction temperature (which may be equivalent to the outlet temperature of the FCC unit 410) can be controlled by opening and closing a catalyst slide valve (not shown) that controls the flow of regenerated FCC catalyst particles from the regeneration zone 422 into the top of the reaction zone 412.

The spent FCC catalyst particles can be passed from the separation zone 414 to the stripper zone 416. In the stripper zone 416, a suitable stripping gas, such as steam, can be introduced through streamline 413. The stripping zone 416 can comprise a plurality of baffles or structured packing (not shown) over which downwardly flowing catalyst particles pass counter-currently relative to the stripping gas. The upwardly flowing stripping gas can strip or remove any additional hydrocarbons, such as reaction products or unreacted hydrocarbons from the feed, that remain in the pores of the spent FCC catalyst particles or between the FCC catalyst particles.

The spent FCC catalyst particles may be passed from the stripper zone 416 via conduit 415 to the catalyst regeneration unit 420. The spent FCC catalyst particles may be transported by lift forces from a combustion air stream 421 through a lift riser of the catalyst regeneration unit 420. The spent FCC catalyst particles may then be contacted with additional combustion air and subjected to controlled combustion in the regeneration zone 422 to remove coke deposits and heat the FCC catalyst particles to produce regenerated FCC catalyst particles. Flue gasses may be removed from the regeneration zone 422 via conduit 425. In the regenerator, the heat produced from the combustion of any coke by-product can be transferred to the FCC catalyst particles, which increases the temperature of the FCC catalyst to provide the heat required by the catalytic reactions in the reaction zone 412.

In embodiments, the FCC reactor may be operated at a reaction temperature of at least about 500° C., such as a reaction temperature of from 500° C. to 800° C., from 550° C. to 800° C., from 600° C. to 800° C., from 650° C. to 800° C., from 500° C. to 750° C., from 550° C. to 750° C., from 600° C. to 750° C., from 650° C. to 750° C., from 500° C. to 700° C., from 550° C. to 700° C., from 600° C. to 700° C., or from 650° C. to 700° C. Steam may be injected to the FCC reactor. The hydrocarbon feed may be catalytically cracked in the presence of the steam with the hierarchical mesoporous ZSM-5 zeolite. The steam to the hydrocarbon mass ratio in the FCC reactor may be from 0.2 to 0.8, from 0.3 to 0.8, from 0.4 to 0.8, from 0.5 to 0.8, from 0.2 to 0.7, from 0.3 to 0.7, from 0.4 to 0.7, from 0.5 to 0.7, from 0.2 to 0.6, from 0.3 to 0.6, from 0.4 to 0.6, or from 0.5 to 0.6. Steam may refer to all water in the FCC reactor. In embodiments, the residence time of the hydrocarbon feed and the steam in contact with the cracking catalyst in the FCC reactor may be from 1 second to 20 seconds, from 2 seconds to 20 seconds, from 5 seconds to 20 seconds, from 8 seconds to 20 seconds, from 1 second to 18 seconds, from 2 seconds to 18 seconds, from 5 seconds to 18 seconds, from 8 seconds to 18 seconds, from 1 second to 16 seconds, from 2 seconds to 16 seconds, from 5 seconds to 16 seconds, from 8 seconds to 16 seconds, from 1 second to 14 seconds, from 2 seconds to 14 seconds, from 5 seconds to 14 seconds, from 8 seconds to 14 seconds, from 1 second to 12 seconds, from 2 seconds to 12 seconds, from 5 seconds to 12 seconds, or from 8 seconds to 12 seconds. In embodiments, the cracking catalyst to hydrocarbon (catalyst to oil) weight ratio in the FCC reactor may be from 3 to 40, such as from 3 to 30, from 3 to 20, from 5 to 40, from 5 to 30, from 5 to 20, from 5 to 10, from 7 to 40, from 7 to 30, 7 to 20, from 7 to 10, from 10 to 40, from 10 to 30, from 10 to 20, or from 20 to 40. The cracking effluent from the FCC reactor can be separated into various product streams, intermediate streams, and an aqueous stream in a separation system downstream of the FCC reactor.

A first aspect of the present disclosure is directed to a method of preparing a cracking catalyst, the method comprising converting one or more clay mineral compositions to metakaolin; synthesizing an intermediate ZSM-5 zeolite from the metakaolin, a silica source, and ZSM-5 zeolite seeds; and forming a cracking catalyst comprising a hierarchical mesoporous ZSM-5 zeolite through disintegration and recrystallization of the intermediate ZSM-5 zeolite.

A second aspect of the present disclosure may include the first aspect, further comprising impregnating the hierarchical mesoporous ZSM-5 zeolite with manganese-containing compounds, zirconium-containing compounds, or both manganese-containing compounds and zirconium-containing compounds to form the cracking catalyst.

A third aspect of the present disclosure may include either one of the first or second aspects, where the synthesizing the intermediate ZSM-5 zeolite comprises forming a slurry by combining at least the metakaolin, silica particles, and zeolite seeds comprising a shape-selective zeolite, and hydrothermally treating the slurry.

A fourth aspect of the present disclosure may include any one of the first through third aspects, where the disintegration and recrystallization of the intermediate ZSM-5 zeolite comprises: disintegrating a portion of the intermediate ZSM-5 zeolite in a first mixture comprising sodium hydroxide and a surfactant; after the at least partially disintegrating the intermediate ZSM-5 zeolite, recrystallizing zeolite constituents in the presence of the surfactant to produce a recrystallized ZSM-5 zeolite having a hierarchical pore structure; and calcining the recrystallized ZSM-5 zeolite, where the calcining removes the surfactant from the recrystallized ZSM-5 zeolite to produce the cracking catalyst comprising a hierarchical mesoporous ZSM-5 zeolite.

A fifth aspect of the present disclosure may include the fourth aspect, where the disintegrating the portion of the intermediate ZSM-5 zeolite comprises: combining the intermediate ZSM-5 zeolite, the sodium hydroxide, and the surfactant to form the first mixture; heating the first mixture to a temperature of 100° C. while stirring; and maintaining the first mixture at the temperature of 100° C. and under stirring for a period of from 18 hours to 30 hours.

A sixth aspect of the present disclosure may include either one of the fourth or fifth aspects, where the recrystallizing the ZSM-5 zeolite constituents comprises: cooling the first mixture to a temperature of from 20° C. to 50° C.; adjusting a pH of the first mixture to 9.0 to produce a second mixture; stirring the second mixture for a second time period of 24 hours; and hydrothermally treating the second mixture by increasing the temperature to 100° C. and stirring for a third period of 24 hours, where stirring for the second time period and hydrothermally treating the second mixture for the third period recrystallizes the zeolite constituents in the presence of the surfactant to produce the recrystallized ZSM-5 zeolite.

A seventh aspect of the present disclosure may include any one of the fourth through sixth aspects, where the calcining the recrystallized ZSM-5 zeolite comprises heating the recrystallized ZSM-5 zeolite at a temperature of from 500° C. to 800° C. for a calcination period of from 4 hours to 24 hours.

An eighth aspect of the present disclosure may include any one of the fourth through seventh aspects, where the first mixture comprises a concentration of sodium hydroxide of from 0.2 molar (M) to 0.5 M.

A ninth aspect of the present disclosure may include any one of the fourth through eighth aspects, where the surfactant comprises cetyltrimethylammonium bromide (CTAB).

A tenth aspect of the present disclosure may include either one of the first through ninth aspects, where the synthesizing the intermediate ZSM-5 zeolite further comprises a templating agent.

An eleventh aspect of the present disclosure may include any one of the first through tenth aspects, further comprising, treating the hierarchical mesoporous ZSM-5 zeolite with 0.25 normality (N) ammonium nitrate twice at 80° C. for 5 hours to produce the hydrogen form of the hierarchical mesoporous ZSM-5 zeolite.

A twelfth aspect of the present disclosure may include any one of the first through eleventh aspects, further comprising: mixing the hierarchical mesoporous ZSM-5 zeolite and a beta zeolite to produce a catalyst blend; and impregnating the catalyst blend with from 1 weight percent to 5 weight percent manganese-containing compounds, zirconium-containing compounds, or both manganese-containing compounds and zirconium-containing compounds to form the cracking catalyst, based on the total weight of the cracking catalyst.

A thirteenth aspect of the present disclosure is directed to a cracking catalyst for steam enhanced catalytic cracking of hydrocarbons, the cracking catalyst comprising a hierarchical mesoporous ZSM-5 zeolite impregnated with manganese, zirconium, or manganese and zirconium, where the cracking catalyst has a mesopore volume of at least 0.30 cubic centimeters per gram (cm³/g).

A fourteenth aspect of the present disclosure may include the thirteenth aspect, where the hierarchical ZSM-5 zeolite has a mesopore volume of from 0.30 centimeters cubed per gram (cm³/g) to 0.50 cm³/g.

A fifteenth aspect of the present disclosure may include either one of the thirteenth or fourteenth aspects, where the hierarchical ZSM-5 zeolite has a mesopore volume greater than or equal to 50% of the total pore volume of the hierarchical mesoporous ZSM-5 zeolite.

A sixteenth aspect of the present disclosure may include any one of the thirteenth through fifteenth aspects, where the manganese is present as manganese oxide and the cracking catalyst comprises from 1 wt. % to 5 wt. % manganese oxide based on the total weight of the cracking catalyst.

A seventeenth aspect of the present disclosure may include any one of the thirteenth through sixteenth aspects, where the zirconium is present as zirconium oxide and the cracking catalyst comprises from 1 wt. % to 5 wt. % zirconium oxide based on the total weight of the cracking catalyst.

An eighteenth aspect of the present disclosure may include any one of the thirteenth through the seventeenth aspects, further comprising a beta zeolite.

A nineteenth aspect of the present disclosure may include the eighteenth aspect, where the beta zeolite comprises from 1 wt. % to 5 wt. % manganese-containing compounds, zirconium-containing compounds, or both manganese-containing compounds and zirconium-containing compounds based on the total weight of the beta zeolite

A twentieth aspect of the present disclosure is directed to a process for upgrading crude oil through steam enhanced catalytic cracking, the process comprising contacting the crude oil with steam in the presence of a cracking catalyst, where: the cracking catalyst comprises a hierarchical mesoporous ZSM-5 zeolite impregnated with manganese, zirconium, or both manganese and zirconium; the hierarchical mesoporous ZSM-5 zeolite has a mesopore volume of at least 0.30 cubic centimeters per gram (cm³/g); a mass ratio of steam to crude oil is from 0.2 to less than 1; and where the contacting of the crude oil with steam in the presence of the cracking catalyst causes at least a portion of crude oil to undergo cracking reactions to produce a cracked effluent comprising light olefins, light aromatic compounds, or both.

A twenty first aspect of the present disclosure may include the twentieth aspect, where the zirconium is present in the cracking catalyst as zirconium oxide, and the cracking catalyst comprises from 1 wt. % to 5 wt. % zirconium oxide based on the total weight of the cracking catalyst.

A twenty second aspect of the present disclosure may include the either one of the twentieth or twenty first aspects, where the manganese is present as manganese oxide and the cracking catalyst comprises from 1 wt. % to 5 wt. % manganese oxide based on the total weight of the cracking catalyst.

A twenty third aspect of the present disclosure may include any one of the twentieth through twenty second aspects, where the crude oil has an American Petroleum Institute gravity of from 15 degrees to 50 degrees.

A twenty fourth aspect of the present disclosure may include any one of the twentieth through twenty third aspects, where the crude oil is a light crude oil, an extra light crude oil, a heavy crude oil, or combinations of these crude oils.

A twenty fifth aspect of the present disclosure may include any one of the twentieth through twenty fourth aspects, comprising contacting the crude oil with the steam in the presence of the cracking catalyst at a temperature of from 525° C. to 800° C. and for a residence time of from 0.1 seconds to 60 seconds.

A twenty sixth aspect of the present disclosure may include any one of the twentieth through twenty fifth aspects, comprising contacting the crude oil with the steam in the presence of the cracking catalyst in a cracking reactor, where the cracking reactor comprises one or more of fixed bed reactors, fluid bed reactors, batch reactors, fluid catalytic cracking (FCC) reactors, moving bed catalytic cracking reactors, or combinations of these.

### EXAMPLES

The various aspects of the present disclosure will be further clarified by the following examples. The examples are illustrative in nature and should not be understood to limit the subject matter of the present disclosure.

### Example 1: Preparation of Metakaolin from a Clay Mineral Composition

In Example 1, metakaolin was prepared by calcining kaolin clay comprising hydrated aluminum silicate (kaolinite). The kaolin clay of Example 1 is commercially available as Kaolin (K7375) from Sigma Aldrich. Metakaolin was formed by heating the kaolin clay in an oven at a ramp rate of 5° C./min until reaching 700° C. The sample was calcined for 2 hours at 700° C. to form metakaolin, which is denoted as Example 1.

### Example 2: Synthesis of an Intermediate ZSM-5 Zeolite

In Example 2, the intermediate ZSM-5 zeolites of the present disclosure were prepared using metakaolin formed in Example 1. In Example 2-1 and Example 2-2 a templating agent was used. In Example 2-3 and Example 2-4 a templating agent was not used. In Example 2-2 and Example 2-4, manganese was impregnated in the intermediate ZSM-5 zeolite.

### Example 2-1

To prepare Example 2-1, an alkaline mixture was prepared by mixing 10 mL of distilled water, 1 gram of sodium hydroxide (NaOH), and Example 1 (1.0 g) and was stirred for 1 hour to form a metakaolin alkaline mixture. Silica particles (Ludox® AS-40 colloidal silica, (Cat. No. 420840), available from Sigma Aldrich) in an amount of 22.83 g were added dropwise to the metakaolin alkaline mixture and stirred for 1 hour to form a metakaolin-nanosilica mixture. The metakaolin-nanosilica mixture was dispersed in deionized water (10 mL) and stirred for 16 hours. An initial ZSM-5 zeolite having a silica to alumina ratio (SAR) of 80, a surface area of 358 m²/g, and pore volume of 0.22 cm³/g (Product No. CBV 8014 ZSM-5 zeolite, available from Zeolyst International) in an amount of 0.09 g was added to the metakaolin-nanosilica solution mixture to act as seeds that facilitated the zeolite growth, and was stirred for 1 hour. After aging for 3 hours, tetrapropylammonium bromide (TPABr) (0.5 g) was added to the seeded metakaolin-nanosilica mixture to form a slurry, and the slurry was kept at room temperature and not stirred for 12 hours. The slurry was transferred to a Teflon-lined autoclave and aged at 175° C. for 72 hours to obtain a hydrothermal product. The hydrothermal product was extracted from the solution by vacuum filtration washed three times with deionized water, and then dried at 100° C. for 12 h. The washed and dried product was calcined at 550° C. for 6 hours. The calcined product was ion exchanged twice using 10 mL of 1M NH₄NO₃ solution per gram of product at 80° C. for 3 hours. The ion-exchanged zeolite was washed and calcined at 500° C. for 2 hours to form the intermediate ZSM-5 zeolite, denoted as Example 2-1.

### Example 2-2

To prepare Example 2-2, an alkaline mixture was prepared by mixing 10 mL of distilled water, 1 gram of sodium hydroxide (NaOH), and the metakaolin of Example 1 (1.0 g) and was stirred for 1 hour to form a metakaolin alkaline mixture. Silica particles (Ludox® AS-40 colloidal silica, (Cat. No. 420840), available from Sigma Aldrich) in an amount of 22.83 g were added dropwise to the metakaolin alkaline mixture and stirred for 1 hour to form a metakaolin-nanosilica mixture. The metakaolin-nanosilica mixture was dispersed in deionized water (10 mL) and stirred for 16 hours. An initial ZSM-5 zeolite having a silica to alumina ratio (SAR) of 80, a surface area of 358 m²/g, and pore volume of 0.22 cm³/g (Product No. CBV 8014 ZSM-5 zeolite, available from Zeolyst International) in an amount of 0.09 g was added to the metakaolin-nanosilica solution mixture to act as seeds that facilitated the zeolite growth, and was stirred for 1 hour After aging for 3 hours, tetrapropylammonium bromide (TPABr) (0.5 g) was added to the seeded metakaolin-nanosilica mixture to form a slurry, and the slurry was kept at room temperature and not stirred for 12 hours. The slurry was transferred to a Teflon-lined autoclave and aged at 175° C. for 72 hours to obtain a hydrothermal product. The hydrothermal product was extracted from the solution by vacuum filtration washed three times with deionized water, and then dried at 100° C. for 12 h. The washed and dried product was calcined at 550° C. for 6 hours. The calcined product was ion exchanged twice using 10 mL of 1M NH₄NO₃ solution per gram of product at 80° C. for 3 hours. The ion exchanged product was then impregnated with manganese and was then washed and calcined at 650° C. for 6 hours to form the intermediate ZSM-5 zeolite, which included 2 wt. % manganese, based on the total weight of the intermediate ZSM-5 zeolite, denoted as Example 2-2.

### Example 2-3

To prepare Example 2-3, an alkaline mixture was prepared by mixing 10 mL of distilled water, 1 gram of sodium hydroxide (NaOH), and the metakaolin of Example 1 (1.0 g) and was stirred for 1 hour to form a metakaolin alkaline mixture. Silica particles (Ludox® AS-40 colloidal silica, (Cat. No. 420840), available from Sigma Aldrich) in an amount of 22.83 g were added dropwise to the metakaolin alkaline mixture and stirred for 1 hour to form a metakaolin-nanosilica mixture. The metakaolin-nanosilica mixture was dispersed in deionized water (10 mL) and stirred for 16 hours. An initial ZSM-5 zeolite having a silica to alumina ratio (SAR) of 80, a surface area of 358 m²/g, and pore volume of 0.22 cm³/g (Product No. CBV 8014 ZSM-5 zeolite, available from Zeolyst International) in an amount of 0.09 g was added to the metakaolin-nanosilica solution mixture to act as seeds that facilitated the zeolite growth, and was stirred for 1 hour and then kept at room temperature and not stirred for 12 hours. The mixture was transferred to a Teflon-lined autoclave and aged at 175° C. for 72 hours to obtain a hydrothermal product. The hydrothermal product was extracted from the solution by vacuum filtration washed three times with deionized water, and then dried at 100° C. for 12 h. The washed and dried product was calcined at 550° C. for 6 hours. The calcined product was ion exchanged twice using 10 mL of 1M NH₄NO₃ solution per gram of product at 80° C. for 3 hours. The ion-exchanged zeolite was washed and calcined at 500° C. for 2 hours to form the intermediate ZSM-5 zeolite, denoted as Example 2-3.

### Example 2-4

To prepare Example 2-4, an alkaline mixture was prepared by mixing 10 mL of distilled water, 1 gram of sodium hydroxide (NaOH), and Example 1 (1.0 g) and was stirred for 1 hour to form a metakaolin alkaline mixture. Silica particles (Ludox® AS-40 colloidal silica, (Cat. No. 420840), available from Sigma Aldrich) in an amount of 22.83 g were added dropwise to the metakaolin alkaline mixture and stirred for 1 hour to form a metakaolin-nanosilica mixture. The metakaolin-nanosilica mixture was dispersed in deionized water (10 mL) and stirred for 16 hours. An initial ZSM-5 zeolite having a silica to alumina ratio (SAR) of 80, a surface area of 358 m²/g, and pore volume of 0.22 cm³/g (Product No. CBV 8014 ZSM-5 zeolite, available from Zeolyst International) in an amount of 0.09 g was added to the metakaolin-nanosilica solution mixture to act as seeds that facilitated the zeolite growth, and was stirred for 1 hour and then kept at room temperature and not stirred for 12 hours. The mixture was transferred to a Teflon-lined autoclave and aged at 175° C. for 72 hours to obtain a hydrothermal product. The hydrothermal product was extracted from the solution by vacuum filtration washed three times with deionized water, and then dried at 100° C. for 12 h. The washed and dried product was calcined at 550° C. for 6 hours. The calcined product was ion exchanged twice using 10 mL of 1M NH₄NO₃ solution per gram of product at 80° C. for 3 hours. The ion exchanged product was then impregnated with manganese and was then washed and calcined at 650° C. for 6 hours to form the intermediate ZSM-5 zeolite, which included 2 wt. % manganese, based on the total weight of the intermediate ZSM-5 zeolite denoted as Example 2-4.

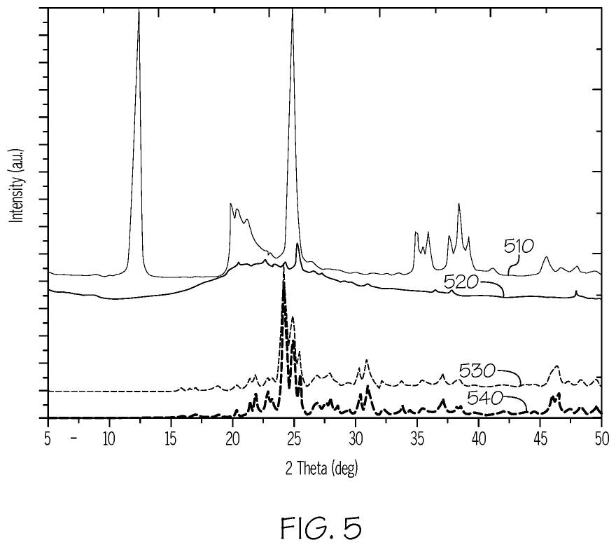

The kaolin clay used in Example 1, the metakaolin formed from calcining the kaolin clay, the intermediate ZSM-5 zeolite of Example 2-1, and the intermediate ZSM-5 zeolite of Example 2-2 were subjected to X-Ray Diffraction (XRD) according to known methods. FIG. 5 graphically depicts the XRD spectra for kaolin clay 520, the intermediate ZSM-5 zeolite of Example 2-1 530, and the intermediate ZSM-5 zeolite of Example 2-2 540. As shown in FIG. 5, calcining the kaolin clay 510 results in the formation of amorphous metakaolin 520. Further, an intermediate ZSM-5 zeolite is synthesized both with a template, as in Example 2-1 (ref. no. 530), and without a template, as in Example 2-2 (ref. no. 540).

The total BET surface area, mesoporous BET surface area, and microporous BET surface area of the intermediate ZSM-5 zeolites of Example 2 are provided in Table 3. The mesoporous BET surface area is the portion of the BET surface area contributed by the mesopores. The microporous BET surface area is the portion of the BET surface area contributed by the micropores.

TABLE 3

| | Total BET | Mesoporous | Microporous |
|---|---|---|---|
| | Surface Area | BET Surface | BET Surface |
| Example | (m²/g) | Area (m²/g) | Area (m²/g) |
| 2-1 | 168 | 45 | 123 |
| 2-2 | 279 | 100 | 179 |
| 2-3 | 257 | 96 | 161 |

The total pore volume of the intermediate ZSM-5 zeolites of Example 2 were determined from measured gas adsorption isotherms through NLDFT modeling and analysis. The mesopore volume and micropore volume were also determined. The total pore volume, mesopore volume, and micropore volume of the intermediate ZSM-5 zeolites of Example 2 are provided in Table 4.

TABLE 4

| | Total Pore | Mesopore | Micropore |
|---|---|---|---|
| Example | Volume (cm³/g) | Volume (cm³/g) | Volume (cm³/g) |
| 2-1 | 0.18 | 0.11 | 0.07 |
| 2-2 | 0.24 | 0.14 | 0.10 |
| 2-3 | 0.17 | 0.08 | 0.09 |

### Example 3: Synthesis of a Cracking Catalyst Including the Hierarchical Mesoporous ZSM-5 Zeolite

In Example 3, the cracking catalyst of the present disclosure comprising the hierarchical mesoporous ZSM-5 zeolite was prepared. To prepare the hierarchical mesoporous ZSM-5 zeolite of Example 3-1, 7 grams of the intermediate ZSM-5 zeolite of Example 2-1 was added to a glass reactor along with a sodium hydroxide (NaOH) solution in water and the surfactant cetyltrimethylammonium bromide (CTAB) to produce the first mixture. The concentration of CTAB in the first mixture was 4.45 wt. % based on the total weight of the first mixture (including the CTAB, NaOH, water, and the intermediate ZSM-5 zeolite). The hierarchical mesoporous ZSM-5 zeolite of Example 3-2 was prepared according to the methods of preparing Example 3-1, but the intermediate ZSM-5 zeolite of Example 2-3 was used instead of the intermediate ZSM-5 zeolite of Example 2-1. The intermediate ZSM-5 zeolites, the molar ratio of silica to alumina in each intermediate ZSM-5 zeolite, and the concentration of NaOH in the first mixture for each of Example 3-1 and Example 3-2 are provided in Table 5.

TABLE 5

| | | Silica to | |
|---|---|---|---|
| | Intermediate | Alumina Molar | NaOH in First |
| Example | Zeolite | Ratio | Mixture (M) |
| 3-1 | Example 2-1 | 80 | 0.2 |
| 3-2 | Example 2-3 | 80 | 0.25 |

For each of Example 3-1 and Example 3-2, the intermediate ZSM-5 zeolite was disintegrated by gradually heating the first mixture comprising the ZSM-5 zeolite, NaOH, and CTAB to 100° C. and stirring the first mixture at 100° C. for a first hydrothermal treatment period of 24 hours. Following the first hydrothermal treatment, the hydrothermally treated mixture was then cooled down, and the pH was adjusted to 9.0 through addition of dilute sulfuric acid (2N (2 normality)) to produce a second mixture. The second mixture was then stirred for 24 hours and aged at 100° C. for another 24 hours. The solid product was filtered, washed thoroughly using distilled water, dried at 80° C. overnight, then calcined at 570° C. for 6 hours to remove the CTAB surfactant to produce the hierarchical mesoporous ZSM-5 zeolites of Example 3-1 and Example 3-2. The hierarchical mesoporous ZSM-5 zeolites were each treated with 0.25 normality (N) ammonium nitrate twice at 80° C. for 5 hours to ion-exchange the hierarchical mesoporous ZSM-5 zeolite in the hydrogen form of the hierarchical mesoporous ZSM-5 zeolite.

The cracking catalyst of Example 3-3 was then produced by impregnating Example 3-1 with 2 wt. % manganese, based on the total weight of the cracking catalyst. Example 3-1 was combined with a solution of manganese nitrate to form a slurry, and the slurry was stirred for 12 hours. The stirred slurry was then dried at 120° C. for 4 hours and calcined at 650° C. for 6 hours. The final cracking catalyst is denoted as Example 3-3.

The total BET surface area, mesoporous BET surface area, and microporous BET surface area of the mesoporous ZSM-5 zeolites of Example 3 are provided in Table 6. The mesoporous BET surface area is the portion of the BET surface area contributed by the mesopores. The microporous BET surface area is the portion of the BET surface area contributed by the micropores.

TABLE 6

| | Total BET | Mesoporous | Microporous |
|---|---|---|---|
| | Surface Area | BET Surface | BET Surface |
| Example | (m²/g) | Area (m²/g) | Area (m²/g) |
| 3-1 | 357 | 222 | 135 |

The total pore volume of the mesoporous ZSM-5 zeolites of Example 3 were determined from measured gas adsorption isotherms through NLDFT modeling and analysis. The mesopore volume and micropore volume were also determined. The total pore volume, mesopore volume, and micropore volume of the mesoporous ZSM-5 zeolites of Example 3 are provided in Table 7.

TABLE 7

| | Total Pore | Mesopore | Micropore |
|---|---|---|---|
| Example | Volume (cm³/g) | Volume (cm³/g) | Volume (cm³/g) |
| 3-1 | 0.31 | 0.24 | 0.07 |

### Example 4: Synthesis of a Cracking Catalyst Including the Hierarchical Mesoporous ZSM-5 Zeolite and a Beta Zeolite

In Example 4, a cracking catalyst of the present disclosure comprising the hierarchical mesoporous ZSM-5 zeolite and a beta zeolite was prepared. The cracking catalysts of Example 4 were varied by the silica to alumina ratio of the initial ZSM-5 zeolite and particle size of the hierarchical mesoporous ZSM-5 zeolite. The cracking catalysts of Example 4 were doped with magnesium oxide.

### Example 4-1

To prepare the cracking catalyst of Example 4-1, 3.5 grams of the hierarchical mesoporous ZSM-5 zeolite of Example 3-1 having a silica to alumina ratio of 80 and an average particle size of approximately 1.0 to 2 μm and 1.5 grams of beta zeolite having a silica to alumina ratio of 40 and an average particle size of approximately 4 μm (Series: HSZ-900, Type: 940NHA, available from Tosoh) were mixed using a mortar and pestle for 10 minutes. The mixture was then impregnated with manganese by combining the mixture with a solution of manganese nitrate to form a slurry, and stirring the slurry for 12 hours. The stirred slurry was then dried at 120° C. for 4 hours and calcined at 650° C. for 6 hours. The final cracking catalyst included 2 wt. % manganese, based on the total weight of the cracking catalyst, and is denoted as Example 4-1.

### Example 4-2

To prepare the cracking catalyst of Example 4-2, a hierarchical mesoporous ZSM-5 zeolite was synthesized according to Example 3-1, but the initial zeolite used as seeds was a ZSM-5 zeolite having a silica to alumina ratio of 23 (Product No. CBV 2314, available from Zeolyst International). 3.5 grams of the hierarchical mesoporous ZSM-5 zeolite having a silica to alumina ratio of 23 and an average particle size of 100-1000 nm and 1.5 grams of beta zeolite having a silica to alumina ratio of 40 and an average particle size of approximately 4 μm (Series: HSZ-900, Type: 940NHA, available from Tosoh Corporation) were mixed using a mortar and pestle for 10 minutes. The mixture was then impregnated with manganese by combining the mixture with a solution of manganese nitrate to form a slurry, and stirring the slurry for 12 hours. The stirred slurry was then dried at 120° C. for 4 hours and calcined at 650° C. for 6 hours. The final cracking catalyst included 2 wt. % manganese, based on the total weight of the cracking catalyst, and is denoted as Example 4-2.

### Example 4-3

To prepare the cracking catalyst of Example 4-3, a hierarchical mesoporous ZSM-5 zeolite was synthesized according to Example 3-1, but the initial zeolite used as seeds was a ZSM-5 zeolite having a silica to alumina ratio of 22 (available from CATAL International ltd.). 3.5 grams of the hierarchical mesoporous ZSM-5 zeolite having a silica to alumina ratio of 22 and an average particle size of approximately 3 μm and 1.5 grams of beta zeolite having a silica to alumina ratio of 40 and an average particle size of approximately 4 μm (Series: HSZ-900, Type: 940NHA, available from Tosoh Corporation) were mixed using a mortar and pestle for 10 minutes. The mixture was then impregnated with manganese by combining the mixture with a solution of manganese nitrate to form a slurry, and stirring the slurry for 12 hours. The stirred slurry was then dried at 120° C. for 4 hours and calcined at 650° C. for 6 hours. The final cracking catalyst included 2 wt. % manganese, based on the total weight of the cracking catalyst, and is denoted as Example 4-3.

### Example 4-4

To prepare the cracking catalyst of Example 4-4, a hierarchical mesoporous ZSM-5 zeolite was synthesized according to Example 3-1, but the initial zeolite used as seeds was a ZSM-5 zeolite having a silica to alumina ratio of 280 (Product No. CBV 28014, available from Zeolyst International). 3.5 grams of the hierarchical mesoporous ZSM-5 zeolite having a silica to alumina ratio of 280 and an average particle size of 0.4-2.5 μm and 1.5 grams of beta zeolite having a silica to alumina ratio of 40 and an average particle size of approximately 4 μm (Series: HSZ-900, Type: 940NHA, available from Tosoh Corporation) were mixed using a mortar and pestle for 10 minutes. The mixture was then impregnated with manganese by combining the mixture with a solution of manganese nitrate to form a slurry, and stirring the slurry for 12 hours. The stirred slurry was then dried at 120° C. for 4 hours and calcined at 650° C. for 6 hours. The final cracking catalyst included 2 wt. % manganese, based on the total weight of the cracking catalyst, and is denoted as Example 4-4.

### Example 4-5

To prepare the cracking catalyst of Example 4-5, a hierarchical mesoporous ZSM-5 zeolite was synthesized according to Example 3-1, but the initial zeolite used as seeds was a ZSM-5 zeolite having a silica to alumina ratio of 1500 and an average particle size of approximately 10 μm (Series: HSZ-800, Type: 890HOA available from Tosoh Corporation). 3.5 grams of the hierarchical mesoporous ZSM-5 zeolite having a silica to alumina ratio of 1500 and an average particle size of 100 to 1000 nm and 1.5 grams of beta zeolite having a silica to alumina ratio of 40 and an average particle size of approximately 4 μm (Series: HSZ-900, Type: 940NHA, available from Tosoh Corporation) were mixed using a mortar and pestle for 10 minutes. The mixture was then impregnated with manganese by combining the mixture with a solution of manganese nitrate to form a slurry, and stirring the slurry for 12 hours. The stirred slurry was then dried at 120° C. for 4 hours and calcined at 650° C. for 6 hours. The final cracking catalyst included 2 wt. % manganese, based on the total weight of the cracking catalyst, and is denoted as Example 4-5.

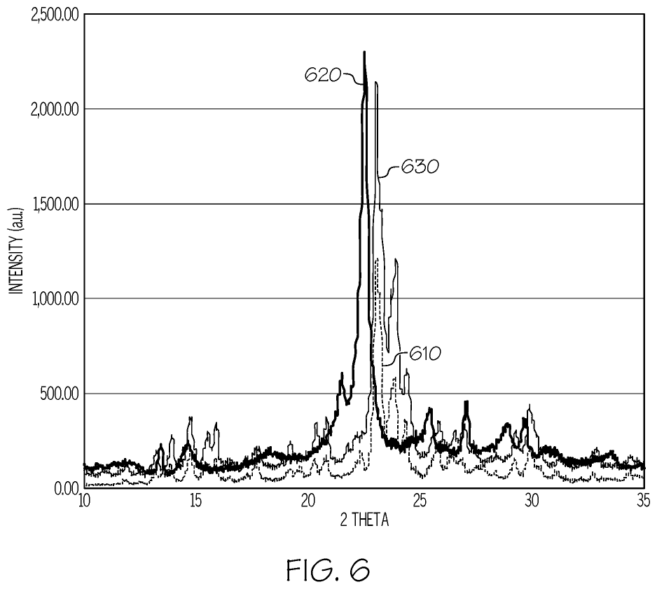

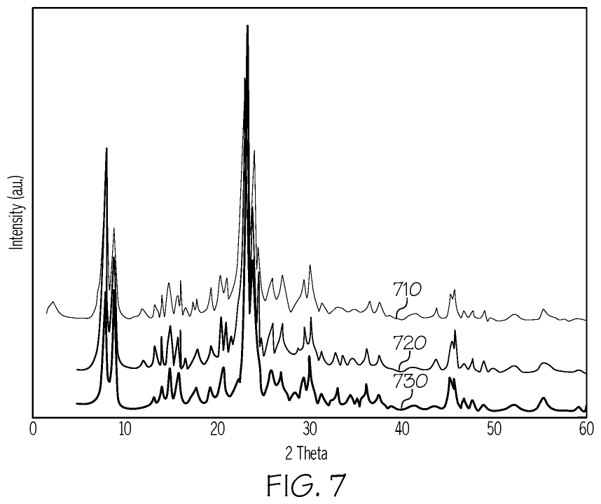

The hierarchical ZSM-5 zeolite of Example 3-1, zeolite beta used in Example 4, and the cracking catalysts of Example 4 were subjected to X-Ray Diffraction (XRD) according to known methods. Referring to FIGS. 6 and 7, FIG. 6 graphically depicts the XRD spectra for the hierarchical ZSM-5 zeolite of Example 3-1 610, the zeolite beta 620, and the cracking catalyst of Example 4-1 630. The diffraction pattern of the cracking catalyst 630 shows formation of a composite comprising the hierarchical ZSM-5 zeolite of Example 3-1 610 and the beta zeolite 620. FIG. 7 graphically depicts the XRD spectra for the cracking catalyst of Example 4-1 710, Example 4-2 720, and Example 4-3 730. The mesoporous phase of Example 4-3 is clearly established by the low angle peak at 2 theta (2θ)=0.2 to θ=3.0, indicating the larger pore size of the mesoporous structure.

The total BET surface area, mesoporous BET surface area, and microporous BET surface area of the cracking catalysts of Example 4 are provided in Table 8. The mesoporous BET surface area is the portion of the BET surface area contributed by the mesopores. The microporous BET surface area is the portion of the BET surface area contributed by the micropores. The mesoporous BET surface area represented about 84% and 40% of the total BET surface area of the cracking catalyst of Example 4-1 and Example 4-2, respectively.

TABLE 8

| | | Mesoporous | Microporous |
|---|---|---|---|
| | Total BET Surface | BET Surface | BET Surface |
| Example | Area (m²/g) | Area (m²/g) | Area (m²/g) |
| 4-1 | 484 | 406 | 78 |
| 4-2 | 550 | 220 | 330 |

The total pore volume of the cracking catalysts of Example 4 were determined from measured gas adsorption isotherms through NLDFT modeling and analysis. The mesopore volume and micropore volume were also determined. The total pore volume, mesopore volume, and micropore volume of the cracking catalysts of Example 4 are provided in Table 9. The mesopore volume represented about 91% and 53% of the total pore volume of the cracking catalyst of Example 4-1 and Example 4-2, respectively.

TABLE 9

| | Total Pore | Mesopore | Micropore |
|---|---|---|---|
| Example | Volume (cm³/g) | Volume (cm³/g) | Volume (cm³/g) |
| 4-1 | 0.43 | 0.39 | 0.04 |
| 4-2 | 0.38 | 0.20 | 0.18 |

### Example 5: Synthesis of a Cracking Catalyst Comprising Zirconium

To prepare the zirconium ZSM-5 zeolite of Example 5, a mixture was prepared by mixing 72 mL of distilled water and 4.26 g of tetrapropylammonium bromide (TPABr), followed by stirring for 1 hour. 7.407 g of ammonium fluoride (NH₄F) was added to the mixture and stirred for 1 hour. Then, 0.58 g of zirconium (IV) chloride and 0.93 g of aluminum nitrate nonahydrate was added to the mixture and stirred until dissolved resulting in a silica-to-zirconium ratio of 80. 12 g of fumed silica was added to the mixture, resulting in a silica-to-alumina ratio of 80. The mixture was homogenized to produce a gel. The produced gel was hydrothermally aged at 200° C. for 2 days to obtain a hydrothermal product. The hydrothermal product was filtered, dried and calcined at 600° C. for 10 hours. The calcined product was ion exchanged twice using 10 mL of 1M NH₄NO₃ solution per gram of product at 80° C. for 3 hours. The ion-exchanged product was washed and calcined at 500° C. for 2 hours, forming 2 wt % Zr/ZSM-5 zeolite having an average particle size of 1-50 μm, denoted as Example 5.

### Comparative Example A: Synthesis of a Cracking Catalyst Including a Mesoporous ZSM-5 Zeolite Formed without Metakaolin

To prepare the mesoporous ZSM-5 zeolite of Comparative Example A, a mixture was prepared by mixing 72 mL of distilled water and 4.26 g of tetrapropylammonium bromide (TPABr), followed by stirring for 1 hour. 7.407 g of ammonium fluoride (NH₄F) was added to the mixture and stirred for 1 hour. Then, 0.93 g of aluminum nitrate nonahydrate was added to the mixture and stirred until dissolved. 12 g of fumed silica was added to the mixture, resulting in a silica-to-alumina ratio of 80. The mixture was homogenized to produce a gel. The produced gel was hydrothermally aged at 200° C. for 2 days to obtain a hydrothermal product. The hydrothermal product was filtered, dried and calcined at 600° C. for 10 hours. The calcined product was ion exchanged twice using 10 mL of 1M NH₄NO₃ solution per gram of product at 80° C. for 3 hours. The ion-exchanged product was washed and calcined at 500° C. for 2 hours. The calcined product was then impregnated with 2 wt. % of Mn (0.045 g/g of support) and calcined at 650° C. for 6 hours to form 2 wt % Mn/ZSM-5 zeolite having an average particle size of 1-50 μm, denoted as Comparative Example A.

### Example 6: Cracking Catalyst Composition Evaluation

In Example 6, the cracking catalysts of Example 4, Example 5, and Comparative Example A were evaluated at atmospheric pressure in a fixed-bed reactor (FBR) system for steam catalytic cracking of AXL crude oil. The general make-up of the AXL crude oil, which was used as the hydrocarbon feed, is provided in Table 10. The cracked gaseous and liquid products were characterized by off-line gas chromatographic (GC) analysis using simulated distillation and naphtha analysis techniques.

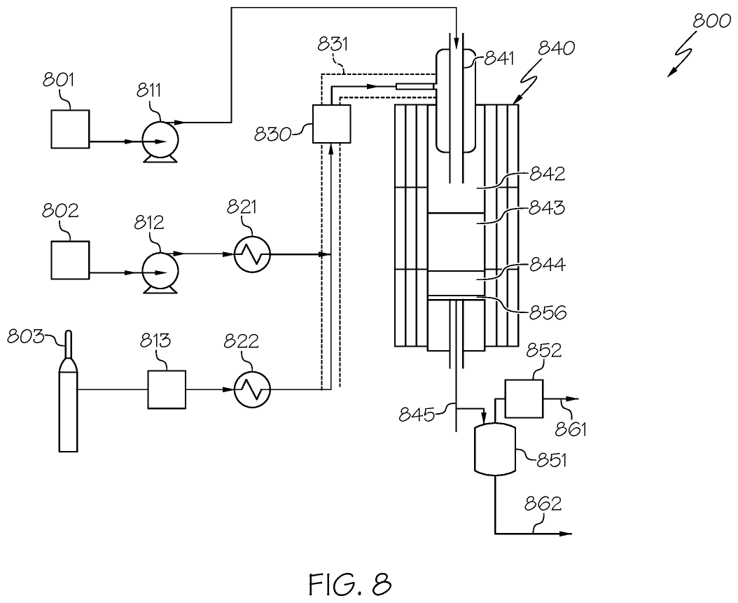

Referring now to FIG. 8, the FBR system 800 for conducting the experiments of Example 6 is schematically depicted. AXL crude oil 801 was fed to a fixed-bed reactor 840 using a metering pump 811. A constant feed rate of 2 g/h of the AXL crude oil 801 was used. Water 802 was fed to the fixed bed reactor 840 using a metering pump 812. Water 802 was preheated using a preheater 821. A constant feed rate of 1 g/h of water 802 was used. Nitrogen 803 was used as a carrier gas at 65 mL/min. Nitrogen 803 was fed to the fixed bed reactor 840 using a Mass Flow Controller (MFC) 813. Nitrogen 803 was preheated using a preheater 822. Water 802 and Nitrogen 803 were mixed using a mixer 830 and the mixture was introduced to the fixed-bed reactor 840. Prior to entering the reactor tube, the AXL crude oil 801, water 802, and nitrogen 803 were preheated to 250° C. in the pre-heating zone 842. The pre-heating zone 842 was pre-heated using line heaters 831. The AXL crude oil 801 was introduced from the top of the reactor 840 through the injector 841 and mixed with steam in the top two-third of the reactor tube 840 before reaching the catalyst bed 844.

The catalyst bed 844 in the reactor tube 840 was moved a few centimeters down to allow more time for pre-heating of the AXL crude oil 801 prior to contacting with the catalyst in the catalyst bed 844. For each experiment, 1 gram (g) of catalyst (25 wt. % cracking catalyst particles of Example 4-1, Example 4-2, Example 4-3, Example 4-4, Example 4-5, Example 5, or Comparative Example A and 75 wt. % Ecat (Equilibrium catalyst, W.R. Grace & Co-Conn) having a mesh size of 30-40 was placed at the center of the reactor tube 840, supported by quartz wool 843, 846 and a reactor insert 845. Quartz wool 843, 846 was placed both at the bottom and top of the catalyst bed 844 to keep it in position. The height of the catalyst bed 844 was 1-2 cm. The cracking catalyst particles of Example 4-1, Example 4-2, Example 4-3, Example 4-4, Example 4-5, Example 5, or Comparative Example A in combination with Ecat were each used as the cracking catalyst in a different experiment conducted for Example 6. Prior to conducting the steam catalytic cracking reaction, each of the cracking catalysts of Example 4, Example 5, and Comparative Example A were steam deactivated in the presence of steam at a temperature of 810° C. for 6 hours.

Following steam deactivation, the hydrocarbon feed comprising the AXL crude oil and the water/steam were introduced to the reaction tube of the FBR. The reaction was allowed to take place for 45-60 min, until steady state was reached. The mass ratio of steam to crude oil was 0.5 grams of steam per gram of crude oil. The AXL crude oil was steam catalytically cracked at a cracking temperature of 675° C. and a weight ratio of catalyst to crude oil of 1:2. The residence time of the crude oil and the steam in the fixed bed reactor 840 was 10 seconds. The total time on stream for each individual experiment of Example 6 was 5 hours.

Referring again to FIG. 8, the cracking reaction product stream 845 was introduced to a gas-liquid separator 851 to separate the cracking reaction product stream 845 into cracked gaseous products 861 and liquid products 862. A Wet Test Meter 852 was placed downstream of the gas-liquid separator 851. The cracked gaseous products 861 and liquid products 862 were characterized by off-line gas chromatographic (GC) analysis using simulated distillation and naphtha analysis techniques. The reaction product streams from the cracking reaction were analyzed for yields of ethylene, propylene, and butylene. The yield analyses for Example 6 are provided numerically in Table 10.

TABLE 10

| | Stream | | | | | | | |
|---|---|---|---|---|---|---|---|---|
| | Feed - | Effluent | Effluent | Effluent | Effluent | Effluent | Effluent | Effluent |
| | AXL Crude | Example | Example | Example | Example | Example | Example | Comparative |
| Catalyst | — | 4-1 | 4-2 | 4-3 | 4-4 | 4-5 | 5 | Example A |
| Silica to | — | 80 | 23 | 22 | 280 | 1500 | 80 | 80 |
| alumina | | | | | | | | |
| ratio of | | | | | | | | |
| ZSM-5 | | | | | | | | |
| zeolite in | | | | | | | | |
| cracking | | | | | | | | |
| catalyst | | | | | | | | |
| Average | — | 1.0-2.0 | 0.1-1.0 | 3.0 | 0.4-2.5 | 0.1-1.0 | 0.1-1.0 | 0.1-1.0 |
| particle size | | | | | | | | |
| of ZSM-5 | | | | | | | | |
| zeolite in | | | | | | | | |
| cracking | | | | | | | | |
| catalyst | | | | | | | | |
| (μm) | | | | | | | | |
| Impregnated | — | 2 wt. % | 2 wt. % | 2 wt. % | 2 wt. % | 2 wt. % | 2 wt. % | 2 wt. % |
| metal in | | Mn | Mn | Mn | Mn | Mn | Zr. | Mn |
| cracking | | | | | | | | |
| catalyst | | | | | | | | |
| Temperature | — | 675 | 675 | 675 | 675 | 675 | 675 | 675 |
| (° C.) | | | | | | | | |
| Steam/Oil | — | 0.5 | 0.5 | 0.5 | 0.5 | 0.5 | 0.5 | 0.5 |
| Weight | | | | | | | | |
| Ratio | | | | | | | | |
| Residence | — | 10 | 10 | 10 | 10 | 10 | 10 | 10 |
| Time | | | | | | | | |
| (seconds) | | | | | | | | |
| Fuel Gas | — | 9.3 | 8.7 | 9.8 | 7.6 | 7.9 | 8.5 | 8.3 |
| (C₁ & H₂) | | | | | | | | |
| (wt. %) | | | | | | | | |
| Saturated | — | 5.7 | 4.7 | 5.6 | 5.7 | 4.9 | 4.5 | 5.7 |
| C₂-C₄ | | | | | | | | |
| (wt. %) | | | | | | | | |
| Ethylene | — | 17.8 | 18.1 | 19.2 | 16.2 | 14.8 | 18.0 | 15.8 |
| (wt. %) | | | | | | | | |
| Propylene | — | 17.2 | 15.7 | 17.6 | 17.4 | 13.5 | 16.7 | 17.1 |
| (wt. %) | | | | | | | | |
| Total | — | 8.2 | 9.1 | 8.7 | 8.8 | 10.0 | 10.0 | 8.2 |
| Butenes | | | | | | | | |
| (wt. %) | | | | | | | | |
| Naphtha | 40.8 | 23.0 | 25.7 | 21.0 | 24.4 | 29.4 | 24.5 | 22.5 |
| (15° C.- | | | | | | | | |
| 221° C.) | | | | | | | | |
| (wt. %) | | | | | | | | |
| Middle | 26.3 | 6.9 | 8.0 | 6.2 | 9.4 | 9.4 | 8.2 | 8.2 |
| Distillate | | | | | | | | |
| (221° C.- | | | | | | | | |
| 343° C.) | | | | | | | | |
| (wt. %) | | | | | | | | |
| Heavy | 32.9 | 3.7 | 3.8 | 3.3 | 5.0 | 4.4 | 4.1 | 4.7 |
| (343° C.+) | | | | | | | | |
| (wt. %) | | | | | | | | |
| Coke (wt. %) | — | 8.2 | 6.2 | 8.6 | 5.5 | 5.6 | 5.6 | 9.4 |
| Total (wt. %) | 100 | 100 | 100 | 100 | 100 | 100 | 100 | 100 |
| Total Light | 0.0 | 43.2 | 42.9 | 45.5 | 42.4 | 38.3 | 44.7 | 41.1 |
| Olefins | | | | | | | | |
| (wt. %) | | | | | | | | |

As shown by the results in Table 10, the cracking catalysts of Example 4 comprising the hierarchical mesoporous ZSM-5 zeolite formed from metakaolin impregnated with manganese produced a greater yield of total light olefins (ethylene, propylene, and mixed butenes) compared to Comparative Example A, which was not formed from metakaolin. Further, the cracking catalyst of Example 5 comprising ZSM-5 zeolite impregnated with zirconium produced a greater yield of total light olefins compared to Comparative Example A. These results clearly demonstrate that the cracking catalysts of Example 4 comprising the hierarchical mesoporous ZSM-5 zeolite formed from metakaolin could be impregnated with zirconium to produce a greater yield of total light olefins.

It is noted that any two quantitative values assigned to a property may constitute a range of that property, and all combinations of ranges formed from all stated quantitative values of a given property are contemplated in this disclosure.

It is noted that one or more of the following claims utilize the term “where” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

Having described the subject matter of the present disclosure in detail and by reference to specific aspects, it is noted that the various details of such aspects should not be taken to imply that these details are essential components of the aspects. Rather, the claims appended hereto should be taken as the sole representation of the breadth of the present disclosure and the corresponding scope of the various aspects described in this disclosure. Further, it will be apparent that modifications and variations are possible without departing from the scope of the appended claims.

What is claimed is:

1. A method of preparing a cracking catalyst, the method comprising:
converting one or more clay mineral compositions to metakaolin;
synthesizing an intermediate ZSM-5 zeolite from the metakaolin, a silica source, and ZSM-5 zeolite seeds; and
forming a cracking catalyst comprising a hierarchical mesoporous ZSM-5 zeolite through disintegration and recrystallization of the intermediate ZSM-5 zeolite.

2. The method of claim 1, further comprising impregnating the hierarchical mesoporous ZSM-5 zeolite with manganese-containing compounds, zirconium-containing compounds, or both manganese-containing compounds and zirconium-containing compounds to form the cracking catalyst.

3. The method of claim 1, where the synthesizing the intermediate ZSM-5 zeolite comprises:
forming a slurry by combining at least the metakaolin, silica particles, and zeolite seeds comprising a shape-selective zeolite; and
hydrothermally treating the slurry.

4. The method of claim 1, where the disintegration and recrystallization of the intermediate ZSM-5 zeolite comprises:
disintegrating a portion of the intermediate ZSM-5 zeolite in a first mixture comprising sodium hydroxide and a surfactant;
after the at least partially disintegrating the intermediate ZSM-5 zeolite, recrystallizing zeolite constituents in the presence of the surfactant to produce a recrystallized ZSM-5 zeolite having a hierarchical pore structure; and
calcining the recrystallized ZSM-5 zeolite, where the calcining removes the surfactant from the recrystallized ZSM-5 zeolite to produce the cracking catalyst comprising a hierarchical mesoporous ZSM-5 zeolite.

5. The method of claim 4, where the disintegrating the portion of the intermediate ZSM-5 zeolite comprises:
combining the intermediate ZSM-5 zeolite, the sodium hydroxide, and the surfactant to form the first mixture;
heating the first mixture to a temperature of 100° C. while stirring; and
maintaining the first mixture at the temperature of 100° C. and under stirring for a period of from 18 hours to 30 hours.

6. The method of claim 4, where the recrystallizing the ZSM-5 zeolite constituents comprises:
cooling the first mixture to a temperature of from 20° C. to 50° C.;
adjusting a pH of the first mixture to 9.0 to produce a second mixture;
stirring the second mixture for a second time period of 24 hours; and
hydrothermally treating the second mixture by increasing the temperature to 100° C. and stirring for a third period of 24 hours, where stirring for the second time period and hydrothermally treating the second mixture for the third period recrystallizes the zeolite constituents in the presence of the surfactant to produce the recrystallized ZSM-5 zeolite.

7. The method of claim 4, where the surfactant comprises cetyltrimethylammonium bromide (CTAB).

8. The method of claim 1, where the synthesizing the intermediate ZSM-5 zeolite further comprises a templating agent.

9. The method of claim 1, further comprising, treating the hierarchical mesoporous ZSM-5 zeolite with 0.25 normality (N) ammonium nitrate twice at 80° C. for 5 hours to produce the hydrogen form of the hierarchical mesoporous ZSM-5 zeolite.

10. The method of claim 1, further comprising:
mixing the hierarchical mesoporous ZSM-5 zeolite and a beta zeolite to produce a catalyst blend; and
impregnating the catalyst blend with from 1 weight percent to 5 weight percent manganese-containing compounds, zirconium-containing compounds, or both manganese-containing compounds and zirconium-containing compounds to form the cracking catalyst, based on the total weight of the cracking catalyst.

11. A cracking catalyst for steam enhanced catalytic cracking of hydrocarbons, the cracking catalyst comprising a hierarchical mesoporous ZSM-5 zeolite impregnated with manganese, zirconium, or manganese and zirconium, where the cracking catalyst has a mesopore volume of at least 0.30 cubic centimeters per gram (cm³/g).

12. The cracking catalyst of claim 11, where the hierarchical ZSM-5 zeolite has a mesopore volume of from 0.30 centimeters cubed per gram (cm³/g) to 0.50 cm³/g.

13. The cracking catalyst of claim 11, where the hierarchical ZSM-5 zeolite has a mesopore volume greater than or equal to 50% of the total pore volume of the hierarchical mesoporous ZSM-5 zeolite.

14. The cracking catalyst of claim 11, where the manganese is present as manganese oxide and the cracking catalyst comprises from 1 wt. % to 5 wt. % manganese oxide based on the total weight of the cracking catalyst.

15. The cracking catalyst of claim 11, where the zirconium is present as zirconium oxide and the cracking catalyst comprises from 1 wt. % to 5 wt. % zirconium oxide based on the total weight of the cracking catalyst.

16. The cracking catalyst of claim 11, further comprising a beta zeolite.

17. The cracking catalyst of claim 16, where the beta zeolite comprises from 1 wt. % to 5 wt. % manganese-containing compounds, zirconium-containing compounds, or both manganese-containing compounds and zirconium-containing compounds based on the total weight of the beta zeolite.

18. A process for upgrading crude oil through steam enhanced catalytic cracking, the process comprising contacting the crude oil with steam in the presence of a cracking catalyst, where:
the cracking catalyst comprises a hierarchical mesoporous ZSM-5 zeolite impregnated with manganese, zirconium, or both manganese and zirconium;
the hierarchical mesoporous ZSM-5 zeolite has a mesopore volume of at least 0.30 cubic centimeters per gram (cm³/g);
a mass ratio of steam to crude oil is from 0.2 to less than 1; and
where the contacting of the crude oil with steam in the presence of the cracking catalyst causes at least a portion of crude oil to undergo cracking reactions to produce a cracked effluent comprising light olefins, light aromatic compounds, or both.

19. The process of claim 18, where the manganese is present as manganese oxide and the cracking catalyst comprises from 1 wt. % to 5 wt. % manganese oxide based on the total weight of the cracking catalyst.

20. The process of claim 18, comprising contacting the crude oil with the steam in the presence of the cracking catalyst in a cracking reactor, where the cracking reactor comprises one or more of fixed bed reactors, fluid bed reactors, batch reactors, fluid catalytic cracking (FCC) reactors, moving bed catalytic cracking reactors, or combinations of these.
